(19) United States
(12) Patent Application Publication
(10) Pub. No.: US 2007/0229413 A1
(43) Pub. Date: Oct. 4, 2007

(54) ELECTRO-OPTICAL DEVICE, METHOD FOR DRIVING ELECTRO-OPTICAL DEVICE, AND ELECTRONIC APPARATUS

(75) Inventor: Hiroyuki Hara, Chino-shi (JP)

Correspondence Address: OLIFF & BERRIDGE, PLC, P.O. BOX 19928, ALEXANDRIA, VA, 22320, US

(73) Assignee: Seiko Epson Corporation, Tokyo (JP)

(21) Appl. No.: 11/689,944

(22) Filed: Mar. 22, 2007

(30) Foreign Application Priority Data
Mar. 28, 2006 (JP) 2006-086812
Dec. 8, 2006 (JP) 2006-331760

(51) Int. Cl. G09G 3/30

(52) U.S. Cl. 345/76

(57) ABSTRACT

An electro-optical device includes a plurality of pixels, a plurality of write scan lines including a predetermined number of the plurality of pixels as a unit, and a drive device driving the plurality of write scan lines non-sequentially and adjusting a light-emission period of the plurality of pixels in accordance with a luminance ratio of an image.

### BACKGROUND

1. Technical Field

Several aspects of the present invention relate to an electro-optical device, a method for driving the electro-optical device, and an electronic apparatus.

2. Related Art

As one of electro-optical devices, a liquid crystal display is typified. Further, as another device, an organic electroluminescent (hereinafter referred to as organic EL) device having an organic EL element as a light-emitting element that requires no backlight has been drawing attention recently. This organic EL element comprises a pair of opposing electrodes and an organic EL layer, i.e. a light-emitting element, provided between the electrodes. The organic EL device that provides a full-color display includes a light-emitting element having a range of emission wavelengths for red, green, and blue. When a voltage is applied between the pair of electrodes opposed to each other, injected electrons and holes are re-combined in the light emitting element, emitting light thereby. The light-emitting element included in this organic EL device comprises a thin film whose thickness is typically less than 1 micrometer. In addition, the device does not require a backlight used in conventional liquid crystal displays since the light-emitting element provides light. Therefore, the device has an advantage in that it can be made extremely thin.

The cathode ray tube (CRT), which has been widely used for displays, provides a peak luminance display to enhance the luminance of a light-emission area that makes up a rather small part of an entire display. Taking an example of displaying images of fireworks, the luminance of a small display area showing sparkling fireworks is set higher when the area is mostly on a dark background than it is mostly on a bright background. This method can provide highly contrasted images. There has been developed a technology to provide a peak luminance display with an organic EL device. The method changes levels of voltage applied to an organic EL element in accordance with a ratio of a light-emission area to an entire display. JP-A-2002-297097 and Inverter kairo wo mochiita den'atsukudogata yuki EL display (Voltage-Driven Organic EL Display with an Inverter Circuit) (Hajime Akimoto, 138th. JOEM Lecture Abstract, Japanese Research Association for Organic Electronics Materials, 13 Jan. 2004, pp. 15-21) are examples of related art.

The peak luminance display is thus available by changing levels of voltage applied to an organic EL element. Changes in the voltage levels to provide the peak luminance display, however, require voltage changes corresponding to the grayscale of display images in line with the changed levels.

For example, if a voltage of 10 V at a maximum is applied to an organic EL element that represents ten grayscale levels, all ten gray scale levels are displayed by changing the voltage applied to the element by every 1 V. However, when a voltage of 15 V at a maximum is applied to the organic EL element to provide the peak luminance display, the voltage applied to the element has to be varied by 1.5 V for representing every grayscale level. The method of related art therefore makes signal processing complicated. In addition, in a case of providing a peak luminance display, it is essential to prevent flickering in a display so as to avoid deterioration of display quality.

### SUMMARY

An advantage of the present invention is to provide an electro-optical device that is capable of controlling luminance in accordance with a ratio of a light-emission area to an entire display without changing a voltage applied, and can achieve a high quality display by preventing flickering occurrence, and a method for driving the electro-optical device, and an electronic apparatus having the electro-optical device.

An electro-optical device according to a first aspect of the invention includes a plurality of pixels, a plurality of write scan lines including a predetermined number of the plurality of pixels as a unit, and a drive device driving the plurality of write scan lines non-sequentially and adjusting a light-emission period of the plurality of pixels in accordance with a luminance ratio of an image.

According to the first aspect of the invention, the light-emission period of the plurality of pixels is adjusted in accordance with the luminance ratio of the image to be displayed (a ratio of a light-emission area to an entire display). Therefore, it is possible to make the light-emission period long when the luminance ratio is small and make the light-emission period short when the luminance ratio is large, for example. As a result, luminance can be controlled in accordance with the luminance ratio of the image to be displayed without changing an applied voltage, thereby providing highly contrasted images as a CRT does. Further, according to the first aspect of the invention, the plurality of write scan lines including the predetermined number of the plurality of pixels as a unit are driven non-sequentially so as to disperse the pixels that are emitting light in an area having the pixels (viewing area). Therefore, even if the light-emission period of the pixels is adjusted to control luminance in accordance with the luminance ratio of the image to be displayed, occurrence of flickering is prevented, thereby providing a high quality display.

Here, the luminance ratio of the image to be displayed mentioned above refers to a ratio of an integrated luminance when all pixels in the viewing area of the electro-optical device produce luminescence at a maximum to an integrated luminance when only some pixels required to display in accordance with the image produce luminescence. Assuming that Lₘₐₓ represents maximum luminance of an individual pixel and Lₖ (k is the number of pixels that are required to produce luminescence in accordance with an image) represents luminance of the individual pixel when only required pixels produce luminescence, the luminance ratio Lᵣ of the image satisfies the formula below:

Lᵣ=ΣLₖ/ΣLₘₐₓ

and the ratio Lᵣ falls within the range of 0 to 1 inclusive.

Further, driving the plurality of write scan lines non-sequentially refers to a drive other than sequential drives in a sequential order. Specifically, for example, a drive of interlacing a plurality of write scan lines spatially, a drive of interlacing a plurality of write scan lines in terms of time, and a drive of interlacing a plurality of write scan lines spatially and in terms of time are cited.

Further, an electro-optical device according to a second aspect of the invention includes a plurality of pixels and a drive device adjusting a light-emission period of the plurality of pixels in accordance with a luminance ratio of an image.

According to the second aspect of the invention, the light-emission period of the plurality of pixels is adjusted in accordance with the luminance ratio of the image to be displayed. Therefore, it is possible to make the light-emission period long when the luminance ratio is small and make the light-emission period short when the luminance ratio is large, for example. As a result, luminance can be controlled in accordance with the luminance ratio of the image to be displayed without changing an applied voltage, thereby providing highly contrasted images as a CRT does.

Here, the electro-optical device according to the second aspect of the invention may be an organic EL device having a light-emitting element included in each of the plurality of pixels.

Alternatively, the electro-optical device according to the second aspect of the invention may be a liquid crystal device including the plurality of pixels each having a pixel electrode, a counter electrode, and a liquid crystal interposed between the pixel electrode and the counter electrode.

Accordingly, the light-emission period of the pixels is adjusted in accordance with the luminance ratio of the image to be displayed, thereby providing highly contrasted images as a CRT does.

Further, in the electro-optical device, the drive device may adjust non-light-emission timing of the plurality of pixels so as to adjust the light-emission period of the plurality of pixels.

Since the light-emission period of the pixels is adjusted by adjusting the non-light-emission timing of the plurality of pixels, it is possible to control luminance in accordance with the luminance ratio of the image to be displayed without making the driving and structure of the plurality of pixels much complicated.

In addition, the electro-optical device may further include a plurality of erase scan lines formed corresponding to the plurality of write scan lines, and a plurality of data lines formed with respect to the predetermined number of the plurality of pixels and extending in a direction intersecting with the plurality of write scan lines and the plurality of erase scan lines. The drive device may make the plurality of pixels emit light via the plurality of write scan lines and not emit light via the plurality of erase scan lines.

Accordingly, the pixels emit light via the write scan lines and not emit light via the erase scan lines, thereby the light-emission period of the pixels is adjusted.

Here, in the electro-optical device, the drive device may drive the plurality of erase scan lines non-sequentially in response to a driving of the plurality of write scan lines.

Accordingly, the erase scan lines are driven non-sequentially in accordance with the driving of the plurality of write scan lines, thereby the light-emission period of the pixels can be easily adjustable even in a case of a non-sequential drive.

In the electro-optical device, the plurality of write scan lines may be divided into zones every predetermined number as a unit in a sequential order and individually driven with respect to each zone by the drive device so as to be driven non-sequentially.

Therefore, the write scan lines divided into zones every predetermined number as a unit are individually driven with respect to each zone. For example, if the write scan lines are divided into four to make a first through a fourth zones, and driven individually by each of the first to fourth zones, the write scan lines as a whole are driven non-sequentially. Specifically, after a first write scan line in the first zone, a first write scan line in the second zone, a first write scan line in the third zone, and a first write scan line in the fourth zone are driven, a second write scan line in the first zone, a second write scan line in the second zone, a second write scan line in the third zone, and a second write scan line in the fourth zone are driven and followed by drives in a similar way. Although the write scan lines are sequentially driven in each zone, in the viewing area of the electro-optical device as a whole, the write scan lines are non-sequentially driven. With such drives, the non-sequential drive of the write scan lines is facilitated.

In the electro-optical device, the plurality of erase scan lines may be divided into zones corresponding to the zones of the plurality of write scan lines and individually driven with respect to each zone by the drive device so as to be driven non-sequentially.

Accordingly, the erase scan lines are divided into zones corresponding to the zones of the plurality of write scan lines, similar to the case of the write scan lines, the erase scan lines are also driven non-sequentially without difficulty.

Further, in the electro-optical device, the drive device may shift a scan start timing of the plurality of write scan lines and a scan start timing of the plurality of erase scan lines by a time period obtained by dividing a predetermined period by the number of zones. The plurality of write scan lines and the plurality of erase scan lines are driven independently with respect to each zone.

Accordingly, the scan start timing of the plurality of write scan lines and the plurality of erase scan lines are divided by the predetermined period so as to disperse the timing of the pixels emitting light. Therefore, flickering to be occurred when the light-emission period of the pixels is adjusted to control luminance in accordance with the luminance ratio of the image to be displayed can be further prevented.

In the electro-optical device, the drive device may drive each of the plurality of write scan lines and the plurality of erase scan lines a plurality of times during the predetermined period by driving the plurality of write scan lines and the plurality of erase scan lines during each period obtained by dividing the predetermined period into a plurality of periods.

Accordingly, the predetermined period is divided into the plurality of periods, and then the plurality of write scan lines and the plurality of erase scan lines are driven during each period being divided. Therefore, each of the plurality of write scan lines and the plurality of erase scan lines is driven the plurality of times, thereby dispersing a position and timing of the pixels emitting light in the viewing area. Flickering is thus effectively prevented from occurring.

Further, in the electro-optical device, the drive device may adjust the light-emission period of the plurality of pixels during each period obtained by dividing the predetermined period into the plurality of periods.

Accordingly, during each period obtained by dividing the predetermined period into the plurality of periods, the light-emission period of the pixels is adjusted to control luminance in accordance with the luminance ratio of the image to be displayed.

In the electro-optical device, each of the plurality of pixels includes a drive element making each of the plurality of pixels emit light based on a signal from the plurality of write scan lines and the plurality of data lines, and a compensation circuit compensating variance of a characteristic of the drive element.

Since each of the pixels includes the compensation circuit that compensates characteristic variance of the drive element making the pixels emit light, high quality image display is achieved.

Further, in the electro-optical device, the plurality of pixels include a red pixel emitting red light, a green pixel emitting green light, and a blue pixel emitting blue light, and the drive device makes each of the red pixel, the green pixel, and the blue pixel emit light with identical light-emission timing, and not emit light with identical non-light-emission timing.

Since the red pixel, the green pixel, and the blue pixel are made to emit light with the identical light-emission timing and made not to emit light with the identical non-light-emission timing, it is possible to control luminance in accordance with the luminance ratio of the image to be displayed without making the driving and structure of the light-emitting element much complicated.

Further, in the electro-optical device, the drive device may adjust the light-emission period of the plurality of pixels in a way that luminance of the plurality of pixels is nonlinear with respect to the luminance ratio of the image to be displayed.

Since the light-emission period of the pixels is adjusted in the way that luminance of the pixels is nonlinear with respect to the luminance ratio of the image to be displayed, it is possible to provide highly contrasted images as a CRT display in related art examples does.

A method for driving an electro-optical device according to a third aspect of the invention includes driving a plurality of write scan lines non-sequentially, and adjusting a light-emission period of the plurality of pixels according to a luminance ratio of an image. The electro-optical device includes a plurality of pixels and the plurality of write scan lines including a predetermined number of the plurality of pixels as a unit.

According to the third aspect of the invention, the light-emission period of the plurality of the pixels is adjusted in accordance with the luminance ratio of the image (the ratio of a light-emission area to an entire display). Therefore, it is possible to make the light-emission period long when the luminance ratio is small and make the light-emission period short when the luminance ratio is large, for example. As a result, luminance can be controlled depending on the luminance ratio of the image without changing an applied voltage, thereby providing highly contrasted images as a CRT does. Further, according to the third aspect of the invention, the plurality of write scan lines including the predetermined number of the plurality of pixels as a unit are driven non-sequentially so as to disperse the pixels that are emitting light in an area having the pixels (viewing area). Therefore, even if the light-emission period of the pixels is adjusted to control luminance in accordance with the luminance ratio of the image to be displayed, occurrence of flickering is prevented, thereby providing a high quality display.

A method for driving an electro-optical device according to a fourth aspect of the invention includes adjusting a light-emission period of a plurality of pixels included in the electro-optical device in accordance with a luminance ratio of an image.

Accordingly, the light-emission period of the plurality of the pixels is adjusted in accordance with the luminance ratio of the image. Therefore, it is possible to make the light-emission period long when the luminance ratio is small and make the light-emission period short when the luminance ratio is large, for example. As a result, luminance can be controlled in accordance with the luminance ratio of the image without changing an applied voltage, thereby providing highly contrasted images as a CRT does.

Further, in the method for driving an electro-optical device, the light-emission period of the plurality of pixels may be adjusted by adjusting non-light emission timing of the plurality of pixels.

Since the light-emission period of the pixels is adjusted by adjusting the non-light-emission timing of the pixels, it is possible to control luminance in accordance with the luminance ratio of the image without making the driving and structure of the pixels much complicated.

In the method for driving an electro-optical device according to the third aspect of the invention, the electro-optical device includes a plurality of erase scan lines corresponding to the plurality of write scan lines, and the plurality of erase scan lines are non-sequentially driven in response to the driving of the plurality of write scan lines.

Accordingly, the erase scan lines are driven non-sequentially in accordance with the driving of the plurality of write scan lines, thereby the light-emission period of the pixels is easy to adjust even in a case of a non-sequential drive.

In the method for driving an electro-optical device, the plurality of write scan lines may be divided into zones every predetermined number as a unit in a sequential order and individually driven with respect to each zone so as to be driven non-sequentially.

Accordingly, the write scan lines divided into zones every predetermined number as a unit are individually driven with respect to each zone. According to the drive as above, for example, the write scan lines are driven sequentially in each zone, but non-sequentially as a whole of the viewing area of the electro-optical device. Consequently, a non-sequential drive of the write scan lines is easy to operate.

In the method for driving an electro-optical device, the plurality of erase scan lines may be divided into zones corresponding to the zones of the plurality of write scan lines and driven individually with respect to each zone so as to be driven non-sequentially.

Accordingly, the erase scan lines are divided into zones corresponding to the zones of the plurality of write scan lines, similar to the case of the write scan lines, the erase scan lines are also driven non-sequentially without difficulty.

An electronic apparatus according to a fifth aspect of the invention includes any electro-optical devices described above.

This structure provides an electronic apparatus capable of displaying quality images.

### BRIEF DESCRIPTION OF THE DRAWINGS

The invention will be described with reference to the accompanying drawings, wherein like numbers reference like elements.

FIG. 1 is a block diagram illustrating an electrical structure of an electro-optical device according to a first embodiment of the invention.

FIG. 2 is a block diagram illustrating a structure of a display panel unit included in the electro-optical device according to the first embodiment of the invention.

FIG. 3 is a circuit diagram illustrating a structure of one of pixels 20 located at the upper left corner of a display panel included in the electro-optical device according to the first embodiment of the invention.

FIG. 4 is a timing chart illustrating signals regarding a data driver 14 in a display panel unit 3 according to the first embodiment of the invention.

FIG. 5 is a timing chart illustrating signals regarding a write scan driver 12 according to the first embodiment of the invention.

FIG. 6 is a circuit diagram illustrating a structure of the write scan driver 12 included in the electro-optical device according to the first embodiment of the invention.

FIG. 7 is a circuit diagram illustrating a structure of the data driver 14 included in the electro-optical device according to the first embodiment of the invention.

FIGS. 8A through 8C are diagrams for explaining a method for driving the electro-optical device according to the first embodiment of the invention.

FIG. 9 is a diagram showing an example of luminance control of a CRT display and a liquid crystal display (LCD).

FIG. 10 illustrates another structure example showing a subpixel 20R.

FIGS. 11A though 11C are diagrams for explaining another example of the method for driving the electro-optical device according to the first embodiment of the invention.

FIG. 12 is a block diagram illustrating a structure of a display panel unit included in an electro-optical device according to a second embodiment of the invention.

FIGS. 13A through 13C are diagrams for explaining a method for driving the electro-optical device according to the second embodiment of the invention.

FIGS. 14A through 14C are diagrams for explaining a method for driving an electro-optical device according to a third embodiment of the invention.

FIG. 15 is a circuit diagram illustrating a structure of one of pixels 20 in a case where the electro-optical device is an LCD according to the invention.

FIGS. 16A through 16C are diagrams illustrating electronic apparatus examples of the invention.

### DESCRIPTION OF EXEMPLARY EMBODIMENTS

Exemplary embodiments of an electro-optical device, a method for driving the electro-optical device, and an electronic apparatus according to the invention are hereinafter described with reference to the accompanying drawings. The embodiments below are shown by way of example, and not intended to limit the invention. It is understood that various modifications can be made without departing from the spirit and scope of the invention. Note that the scale of each layer and member is adequately changed so that they are visible in the drawings.

### First Embodiment

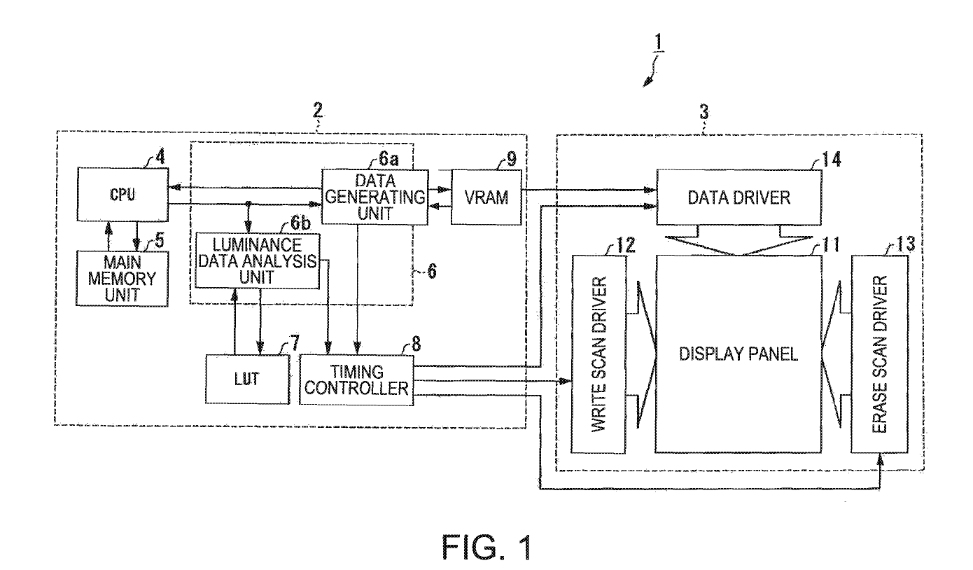

FIG. 1 is a block diagram illustrating an electrical structure of an electro-optical device according to a first embodiment of the invention. As the electro-optical device, an organic EL device is exemplified to describe below. Referring to FIG. 1, an organic EL device 1 as the electro-optical device includes a peripheral drive device 2 and a display panel unit 3. The peripheral drive device 2 includes a central processing unit (CPU) 4, a main memory unit 5, a graphics controller 6, a lookup table (LUT) 7, a timing controller 8 and a video RAM (VRAM) 9. The CPU 4 may be replaced with a microprocessor unit (MPU). The display panel unit 3 includes a display panel 1, a write scan driver 12, an erase scan driver 13, and a data driver 14.

The CPU included in the peripheral drive device 2 reads image data stored in the main memory unit 5, carries out various types of processing, such as expansion, with the main memory unit 5, and outputs processed data to the graphics controller 6. The graphics controller 6 produces image data and synchronizing signals (vertical and horizontal synchronizing signals) for the display panel unit 3 based on the image data output from the CPU 4. The graphics controller 6 transfers the image data produced by its data generating unit 6a to the VRAM 9 and outputs the produced synchronizing signals to the timing controller 8.

The graphics controller 6 also includes a luminance data analysis unit 6b that calculates a luminance ratio of the image data output from the CPU 4 based on the data. Here, the luminance ratio of the image data refers to a ratio of an integrated luminance when every pixel included in the display panel 11, which will be described in greater detail later, produces luminescence at a maximum to the integrated luminance when only some pixels that are required to produce luminescence in accordance with the data.

Assuming that Lₘₐₓ represents the maximum luminance of individual pixels and Lₖ (k is the number of pixels that are required to produce luminescence in accordance with image data) represents luminance of individual pixels when only required pixels produce luminescence, a luminance ratio Lᵣ of the data satisfies the formula below:

Lᵣ=ΣLₖ/ΣLₘₐₓ

and the ratio Lᵣ falls within the range of 0 to 1 inclusive.

When every pixel included in the display panel 11 produces luminescence at a maximum, which means the luminance ratio Lᵣ of the image data is 1, the display panel 11 provides the brightest display. As the luminance ratio Lᵣ of the image data approaches 1, the number of pixels emitting light increases. A light-emission area is thus enlarged, providing a bright display entirely on the display panel 11. In contrast, as the luminance ratio Lᵣ of the image data approaches 0, the number of pixels emitting light decreases. A light-emission area is thus reduced, providing a dark display almost entirely on the display panel 11.

The luminance data analysis unit 6b produces a control signal to adjust a light-emission period of the organic EL element, described in greater detail later, during which the pixel emits light based on the calculated luminance ratio of the image data and data stored in the LUT 7. The graphics controller 6 outputs the control signal produced by the luminance data analysis unit 6b as well as the above-mentioned synchronizing signals to the timing controller 8. The LUT 7 stores data defining the light-emission period of the organic EL element with regard to the luminance ratio of the image data. Control of the light-emission period of the organic EL element based on the data stored in the LUT 7 will be described in greater detail later.

The VRAM 9 outputs the image data from the graphics controller 6 to the data driver 14 included in the display panel unit 3. The timing controller 8 outputs the horizontal synchronizing signal to the data driver 14 included in the display panel unit 33 while outputs the vertical synchronizing signal to the write scan driver 12 also included in the display panel unit 3. The timing controller 8 also outputs an erase scan signal to the erase scan driver 13 included in the display panel unit 3. The erase scan signal makes the organic EL elements in the display panel 11 not emit light. The image data from the VRAM 9 and the signals from the timing controller 8 are synchronized and output to the display panel 11.

[Display Panel Unit 3]

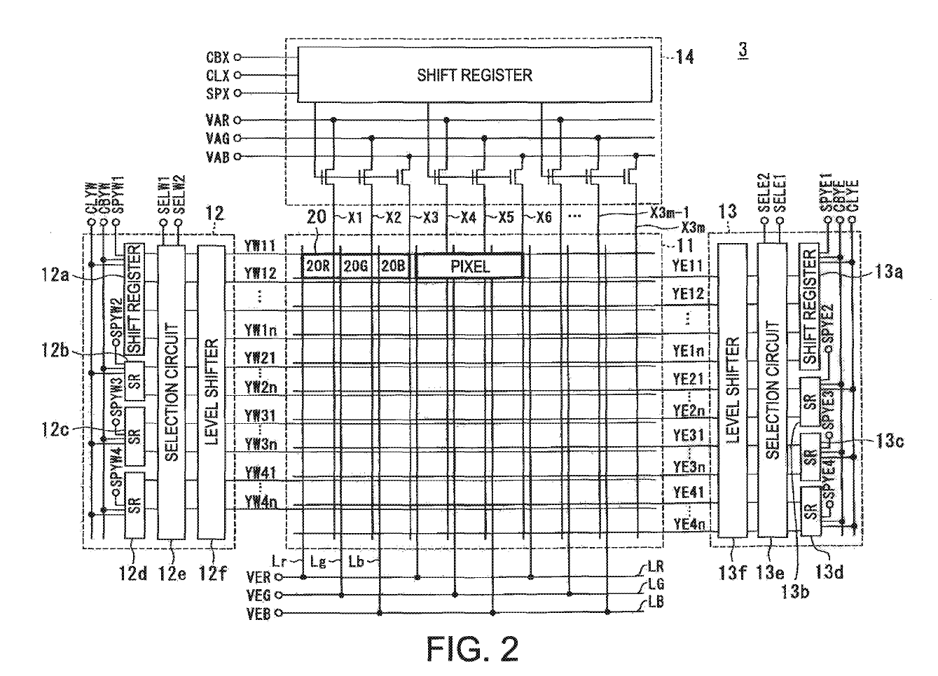

FIG. 2 is a block diagram illustrating a structure of the display panel unit included in the electro-optical device according to the first embodiment of the invention. As shown in the diagram, the display panel 11 in the display panel unit 3 includes 4n-number (n is a natural number) of write scan lines YW11 to YW1n, YW21 to YW2n, YW31 to YW3n, and YW41 to YW4n extending in the row direction and 4n-number of erase scan lines YE11 to YE1n, YE21 to YE2n, YE31 to YE3n, YE41 to YE4n extending in the row direction and corresponding to the write scan lines. That is, in the embodiment, the 4n-number of the write scan lines and the 4n-number of the erase scan lines are divided into four zones every n-number lines as a unit. The write scan lines and the erase scan lines are divided as such in order to facilitate their non-sequential drives. A method for driving the write scan lines and the erase scan lines will be described in details later. The display panel 11 also includes 3m-number of data lines X1 to X3m (m is a natural number) extending in the column direction intersected with the row direction.

Further, the display panel 11 also includes a plurality of pixels 20 disposed at intersections of the write scan lines YW11 to YW1n, YW21 to YW2n, YW31 to YW3n, and YW41 to YW4n (erase scan lines YE11 to YE1n, YE21 to YE2n, YE31 to YE3n, and YE41 to YE4n) and the data lines X1 to X3m. That is, the pixels 20 are respectively disposed at the intersections of the write scan lines YW11 to YW1n, YW21 to YW2n, YW31 to YW3n, and YW41 to YW4n (erase scan lines YE11 to YE1n, YE21 to YE2n, YE31 to YE3n, and YE41 to YE4n) extending in the row direction and the data lines X1 to X3m extending in the column direction so as to be in a matrix by being electrically coupled.

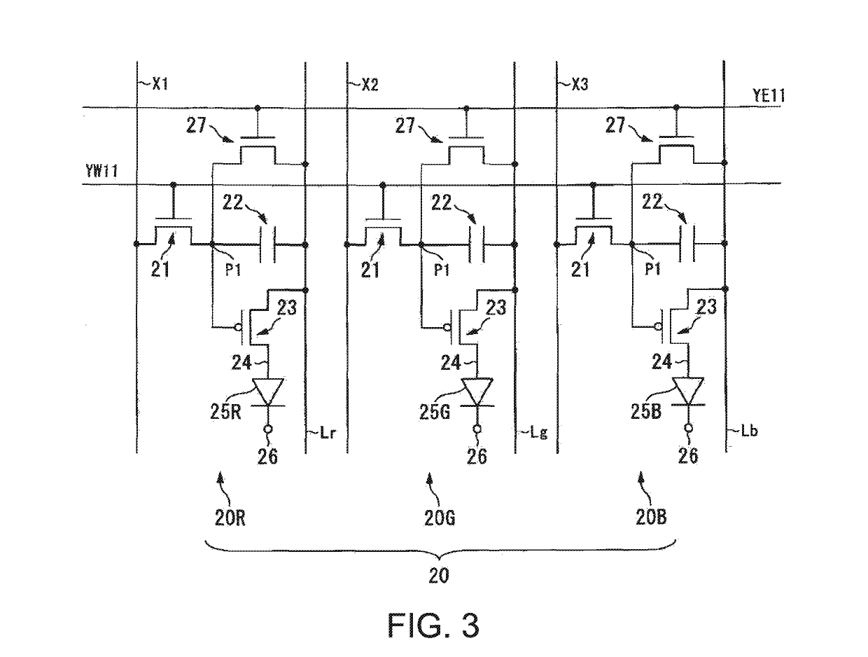

FIG. 3 is a circuit diagram illustrating a structure of one of the pixels 20 located at the upper left corner of the display panel included in the electro-optical device according to the first embodiment of the invention. As shown in the diagram, the pixel 20 on the upper left corner of the display panel 11 includes a subpixel 20R emitting red light, a subpixel 20G emitting green light from its light-emitting layer, and a subpixel 20B emitting blue light from its light-emitting layer. The other pixels included in the display panel 11 also have the structure made up of the subpixels 20R, 20G, and 20B.

The subpixel 20R includes a switching thin-film transistor (TFT) 21 whose gate electrode receives a write scan signal via the write scan line YW11, a storage capacitor 22 retaining a pixel signal supplied from the data line X1 via this switching TFT 21, a driving TFT 23 whose gate electrode receives the pixel signal retained by the storage capacitor 22, a pixel electrode (electrode) 24 receiving a driving current from a power line Lr when electrically coupled with the line Lr via the driving TFT 23, and an organic EL element 25R interposed between the pixel electrode 24 and a common electrode 26. In addition, another switching TFT 27 whose gate electrode receives an erase scan signal via the erase scan line YE11 is provided. A source electrode of this switching TFT is coupled with the power line Lr, while a drain electrode of the TFT is coupled with a point P1 connecting the switching TFT 21, the storage capacitor 22 and the driving TFT 23.

Similarly, the subpixel 20G includes the switching TFT 21 whose gate electrode receives a write scan signal via the write scan line YW11, the storage capacitor 22 retaining a pixel signal supplied from the data line X2 via this switching TFT 21, the driving TFT 23 whose gate electrode receives the pixel signal retained by the storage capacitor 22, the pixel electrode (electrode) 24 receiving a driving current from a power line Lg when electrically coupled with the line Lg via the driving TFT 23, and an organic EL element 25G interposed between the pixel electrode 24 and the common electrode 26. In addition, another switching TFT 27 whose gate electrode receives an erase scan signal via the erase scan line YE11 is provided. A source electrode of this switching TFT is coupled with the power line Lg, while a drain electrode of the TFT is coupled with the point P1 connecting the switching TFT 21, the storage capacitor 22 and the driving TFT 23.

Likewise, the subpixel 20B includes the switching TFT 21 whose gate electrode receives a write scan signal via the write scan line YW11, the storage capacitor 22 retaining a pixel signal supplied from the data line X3 via this switching TFT 21, the driving TFT 23 whose gate electrode receives the pixel signal retained by the storage capacitor 22, the pixel electrode (electrode) 24 receiving a driving current from a power line Lb when electrically coupled with the line Lb via the driving TFT 23, and an organic EL element 25B interposed between the pixel electrode 24 and the common electrode 26. In addition, another switching TFT 27 whose gate electrode receives an erase scan signal via the erase scan line YE11 is provided. A source electrode of this switching TFT is coupled with the power line Lb, while a drain electrode of the TFT is coupled with the point P1 connecting the switching TFT 21, the storage capacitor 22 and the driving TFT 23.

With this pixel 20, when the write scan line YW11 is driven to turn on the switching TFT 21, potential of the data lines X1, X2, and X3 at this time is stored respectively in the storage capacitors 22 included in the subpixels 20R, 20G, and 20B. The on/off state of the driving TFT 23 included in each of the subpixels 20R, 20G, and 20B is determined depending on the state of each of the storage capacitors 22. A current then flows to the pixel electrode 24 included in each of the subpixels 20R, 20G, and 20B from the power lines Lr, Lg, and Lb, respectively, via a channel in the driving TFT 23. The current therefore flows into the common electrode 26 via each of the organic EL elements 25R, 25G, and 25B. As a result, the organic EL elements 25R, 25G, and 25B emit light in accordance with an amount of current flow.

Supposing that the erase scan line YE11 is driven to turn on the switching TFT 27 included in each of the subpixels 20R, 20G, and 20B while the write scan line YW11 is not driven, potential of the point P1 included in each of the subpixels 20R, 20G, and 20B becomes equal to potential of the power lines Lr, Lg, and Lb, respectively. Accordingly, a potential difference in the storage capacitor 22 is zero and the driving TFT 23 that has been on is turned off. Consequently, driving the erase scan line YE11 reduces the potential difference in the storage capacitor 22 to zero, making the organic EL elements 25R, 25G, and 25B not emit light (become the off state) even if they have emitted light with the potential of the data lines X1, X2, and X3 stored in the storage capacitors 22 included in the each of subpixels 20R, 20G, and 20B.

Referring back to FIG. 2, the plurality of power lines Lr, Lg, and Lb are arranged in the column direction, so that they are adjacent to the subpixels 20R, 20G, and 20B, respectively, in the display panel 11. The power line Lr receives a driving voltage VER via a power supply line LR. Similarly, the power line Lg receives a driving voltage VEG via a power supply line LG, while the power line Lb receives a driving voltage VEB via a power supply line LB. While the present embodiment applies the driving voltages VER, VEG, and VEB that differ from each other to the organic EL elements 25R, 25G, and 25B, respectively, an identical driving voltage may be applied to the elements 25R, 25G, and 25B to drive them by making the power lines Lr, Lg, and Lb and the power supply lines LR, LG, and LB common to the three.

[Peripheral Drive Device 2]

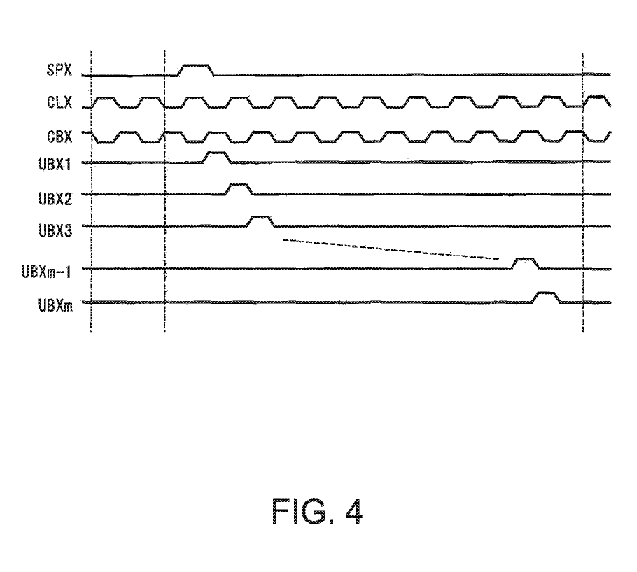

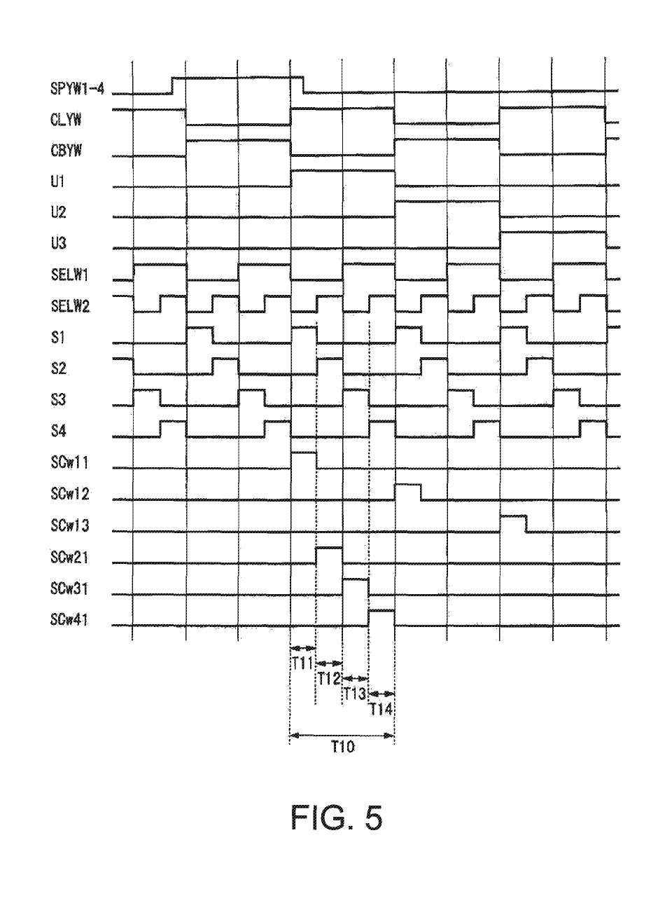

The peripheral drive device 2 will now be described. The peripheral drive device 2 outputs the image data and the synchronizing signals to the display panel unit 3 in sync with a basic clock signal CLK. FIG. 4 is a timing chart of signals for the data driver 14 of the display panel unit 3 according to the first embodiment of the invention while FIG. 5 is a timing chart of signals for the write scan driver 12 according to the same embodiment. Referring to this chart, the peripheral drive device 2 produces a data driver start pulse SPX, a data driver clock signal CLX, and an inverted data driver clock signal CBX, and outputs them to the data driver 14 included in the display panel unit 3.

The data driver start pulse SPX is output every time when one of the write scan lines YW11 to YW1n, YW21 to YW2n, YW31 to YW3n, and YW41 to YW4n is selected. The pulse is a signal to select each of the pixels 20 at a time from left to right in FIG. 2 on the one that is selected. The data driver clock signal CLX and the inverted data driver clock signal CBX are complementary signals. They are signals to shift the data driver start pulse SPX sequentially. According to the embodiment, each of the pixels 20 is made up of a set of the subpixel 20R for red, the subpixel 20G for green, and the subpixel 20B for blue. In response to the data driver clock signal CLX and the inverted data driver clock signal CBX, the data driver start pulse SPX is shifted by using the set as a unit, thereby selecting one set of the subpixels 20R, 20G, and 20B sequentially from left to right in FIG. 2.

The peripheral drive device 2 also produces write scan driver start pulses SPYW1 to SPYW4, a write scan driver clock signal CLYW, and an inverted write scan driver clock signal CBYW shown in FIG. 5 based on the basic clock signal CLK and outputs the signals to the data driver 14. The write scan driver start pulse SPYW1 is a signal output when the write scan line YW11 located on the top is selected out of the write scan lines YW11 to YW1n to be selected one by one sequentially from top to bottom. Similarly, the write scan driver start pulses SPYW2 to SPYW4 are signals output when the write scan lines YW21, YW31, and YW41 located on the top is selected out of the write scan lines YW21 to YW2n, YW31 to YW3n, and YW41 to YW4n each to be selected one by one sequentially from top to bottom. The write scan driver clock signal CLYW and the inverted write scan driver clock signal CBYW are complementary signals. They are signals to shift the write scan driver start pulses SPYW1 to SPYW4 sequentially to select the write scan lines one by one.

The peripheral drive device 2 produces an analog image signal VAR for red, an analog image signal VAG for green, and an analog image signal VAB for blue for each of the pixels 20 (20R, 20G, and 20B) based on image data stored in the main memory unit 5. The peripheral drive device 2 outputs the produced signals VAR, VAG, and VAB to the data driver 14 in sync with the data driver clock signal CLX and the inverted data driver clock signal CBX. In other words, the peripheral drive device 2 outputs the analog image data signals VAR, VAG, and VAB for each of the pixels 20 (20R, 20G, and 20B) selected at a time from left to right on each selected scan line in sync with the data driver clock signal CLX and the inverted data driver clock signal CBX. The signals VAR, VAG, and VAB may fall within a predetermined range and determine the luminance of the organic EL elements 25R, 25G, and 25B included in the pixels 20.

As shown in FIG. 2, the peripheral drive device 2 also produces erase scan driver start pulses SPYE1 to SPYE4, an erase scan driver clock signal CLYE, and an inverted erase scan driver clock signal CBYE based on the basic clock signal CLK and outputs them to the erase scan driver 13. The erase scan driver start pulse SPYE1 is a signal output when the erase scan line YE11 on the top is selected out of the erase scan lines YE11 to YE1n to be selected one by one from top to bottom. Similarly, the erase scan driver start pulses SPYE2 to SPYE4 are signals output when the erase scan lines YE21, YE31, and YE41 located on the top is selected out of the erase scan lines YE21 to YE2n, YE31 to YE3n, and YE41 to YE4n each to be selected one by one sequentially from top to bottom. The erase scan driver clock signal CLYE and the inverted erase scan driver clock signal CBYE are complementary signals. They are signals to shift the erase scan driver start pulses SPYE1 to SPYE4 sequentially to select the erase scan lines one by one.

Further, as shown in FIG. 2, the peripheral drive device 2 produces write selection signals SELW1 and SELW2 and outputs them to the write scan driver 12, and produces erase selection signals SELE1 and SELE2 and outputs them to the erase scan driver 13 based on the basic clock signal CLK. The write selection signals SELW1 and SELW2 are signals to select a zone for the write scan lines to be driven among the write scan lines YW11 to YW1n, YW21 to YW2n, YW31 to YW3n, and YW41 to YW4n, which are made by dividing the write scan lines into four zones. Similarly, the erase selection signals SELE1 and SELE2 are signals to select a zone for the write scan lines to be driven among the erase scan lines YE11 to YE1n, YE21 to YE2n, YE31 to YE3n, and YE41 to YE4n, which are made by dividing the erase scan lines into four zones.

As shown in FIG. 5, the write selection signal SELW1 is a signal for half a period (signal having a double frequency) of the write scan driver clock signal CLYW and the inverted write scan driver clock signal CBYW. Further, the write selection signal SELW2 is a signal for quarter a period (signal having a four-times frequency) of the write scan driver clock signal CLYW and the inverted write scan driver clock signal CBYW. The erase selection signal SELE1 has the same period as that of the write selection signal SELW1 while the erase selection signal SELE2 has the same period as that of the write selection signal SELW2.

The peripheral drive device 2 outputs the write scan driver start pulses SPYW1 to SPYW4 to the write scan driver 12, and then outputs the erase scan driver start pulses SPYE1 to SPYE4 to the erase scan driver 13 at predetermined timing in each frame. This method makes the organic EL elements 25R, 25G, and 25B provided in each of the pixels 20 not emit light (erased) to adjust the light-emission period of each of the elements 25R, 25G, and 25B.

[Write Scan Driver 12 and Erase Scan Driver 13]

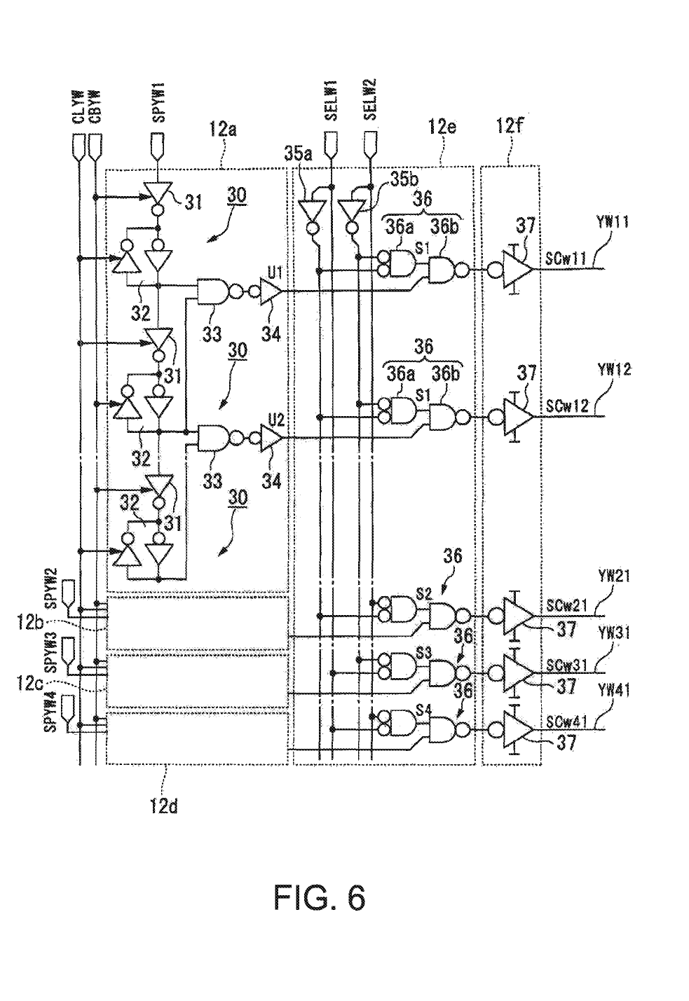

The write scan driver 12 and the erase scan driver 13 will now be described. FIG. 6 is a circuit diagram illustrating a structure of the write scan driver 12 included in the electro-optical device according to the first embodiment of the invention. As shown in the diagram, the write scan driver 12 receives the write scan driver start pulses SPYW1 to SPYW4, the write scan driver clock signal CLYW, the inverted write scan driver clock signal CBYW, and also the write selection signals SELW1 and SELW2 as inputs from the peripheral drive device 2.

The write scan driver 12 includes shift registers 12a to 12d, a selection circuit 12e, and a level shifter 12f. The shift resistors 12a to 12d have almost the same internal structure each other. To each of the shift resisters 12a to 12d, the write scan driver clock signal CLYW and the inverted write scan driver clock signal CBYW, are input. Only difference among the shift resisters 12a to 12d is that the write scan driver start pulses SPYW1 to SPYW4 are respectively input to the shift resisters 12a to 12d. Now the internal structure and operation will be described referring to the shift resister 12a as an example. The shift register 12a includes n-number of storage circuits 30 corresponding to the write scan lines YW11 to YW1n as shown in FIG. 6. Here, in the diagram, only three of the storage circuits 30 are illustrated for simplifying the description. Each of the storage circuits 30 includes an inverter circuit 31, a latch part 32, a NAND circuit 33, and an inverter circuit 34.

The inverter circuit 31 included in each of the storage circuits 30 in odd-numbered stages receives the inverted write scan driver clock signal CBYW as an input, while the inverter circuit 31 included in each of the storage circuits 30 in even-numbered stages receives the write scan driver clock signal CLYW as an input as synchronizing signals. The inverter circuit 31 in each of the storage circuits 30 in the odd-numbered stages receives the write scan driver start pulse SPYW1 as an input in response to a rising of the inverted write scan driver clock signal CBYW1 and outputs the pulse to the latch part 32. The inverter circuit 31 in each of the storage circuits 30 in the even-numbered stages receives the write scan driver start pulse SPYW1 as an input in response to a rising of the write scan driver clock signal CLYW and outputs the pulse to the latch part 32.

The latch part 32 in each of the storage circuits 30 is made up of two inverter circuits. The latch part 32 included in each of the storage circuits 30 in the odd-numbered stages receives the write scan driver clock signal CLYW as an input, while the latch part 32 included in each of the storage circuits 30 in the even-numbered stages receives the inverted write scan driver clock signal CBYW as an input as synchronizing signals. The latch part 32 in each of the storage circuits 30 in the odd-numbered stages receives and retains the write scan driver start pulse SPYW1 as an input from the inverter circuit 31 in response to the rising of the write scan driver clock signal CLYW. The latch part 32 in each of the storage circuits 30 in the even-numbered stages receives and retains the write scan driver start pulse SPYW1 as an input from the inverter circuit 31 in response to the rising of the inverted write scan driver clock signal CBYW. Each latch part 32 outputs the write scan driver start pulse SPYW1 being retained to the inverter circuit 31 in the storage circuits 30 of the next stage. Accordingly, the write scan driver start pulse SPYW1 at the H level output from the peripheral drive device 2 is sequentially shifted from the storage circuit 30 on the write scan line YW11 to the storage circuit 30 on the write scan line YW1n in sync with the write scan driver clock signal CLYW and the inverted write scan driver clock signal CBYW.

The NAND circuit 33 included in one storage circuit 30 has one input terminal coupled with an output terminal of the latch part 32 and another input terminal coupled with an output terminal of the latch part 32 included in another storage circuit 30 of the next stage. When both the latch parts 32 included both in the storage circuit 30 and the next-stage storage circuit 30 retain the write scan driver start pulse SPYW1 at the H level, the NAND circuit 33 included in the storage circuit 30 outputs an L-level signal. The NAND circuit 33 outputs an H-level signal when the latch part 32 in the storage circuit 30 shifts the write scan driver start pulse SPYW1. The NAND circuit 33 continues to output the H-level signal until each latch part 32 newly retains the write scan driver start pulse SPYW1. The inverter circuit 34 inverts logic of the signal output from the N-AND circuit 33. As a result, signals U1 to U3 shown in FIG. 5 are produced in the shift resister 12a, for example. The shift resisters 12b to 12d have the same structure as that of the shift resister 12a and their operation is also the same, therefore the explanation is omitted.

The signals U1 to U3 from the inverter circuit 34 in each of the storage circuits 30 included in the shift resisters 12a to 12d are output to the selection circuit 12e. The selection circuit 12e includes 4n-number of switching circuits 36 corresponding to each of the storage circuits 30 included in inverter circuits 35a and 35b, and the shift resisters 12a to 12d as shown in FIG. 6. The inverter circuit 35a is provided to invert logic of the write selection signal SELW1, while the inverter circuit 35b is provided to invert logic of the write selection signal SELW2. The switching circuit 36 includes a NOR circuit 36a and a NAND circuit 36b.

In the switching circuit 36 included in the selection circuit 12e, the NOR circuit 36a forming the switching circuit 36 that is provided to correspond to each of the storage circuits 30 of the shift resister 12a has one input terminal receiving output from the inverter circuit 35a and another input terminal receiving output from the inverter circuit 35b. On the other hand, the NOR circuit 36a forming the switching circuit 36 that is provided to correspond to each of the storage circuits 30 of the shift resister 12b has one input terminal receiving output from the inverter circuit 35a and another input terminal receiving the write selection signal SELW2. Further, the NOR circuit 36a forming the switching circuit 36 that is provided to correspond to each of the storage circuits 30 of the shift resister 12c has one input terminal receiving the write selection signal SELW1 and another input terminal receiving output from the inverter circuit 35b. Furthermore, the NOR circuit 36a forming the switching circuit 36 that is provided to correspond to each of the storage circuits 30 of the shift resister 12d has one input terminal receiving the write selection signal SELW1 and another input terminal receiving the write selection signal SELW2.

Accordingly, as shown in FIG. 5, by selecting a combination of the write selection signals SELW1 and SELW2, only an output S1 of the NOR circuit 36a included in each of n-number of the switching circuits 36 corresponding to the shift resister 12a is at the H level (selection period T11), while only an output S2 of the NOR circuit 36a included in each of n-number of the switching circuits 36 corresponding to the shift resister 12b is at the H level (selection period T12). Further, only an output S3 of the NOR circuit 36a included in each of n-number of the switching circuits 36 corresponding to the shift resister 12c is at the H level (selection period T13), while only an output S4 of the NOR circuit 36a included in each of n-number of the switching circuits 36 corresponding to the shift resister 12d is at the H level (selection period T14). Therefore, in this embodiment, four scan lines are driven by a period T10 that is a half period for the write scan driver clock signal CLYW and the inverted write scan driver clock signal CBYW. The NAND circuit 36b includes one input terminal coupled to an output terminal of the NOR circuit 36a corresponding thereto and another input terminal coupled to an output terminal of the inverter circuit 34 included in the storage circuit 30 corresponding thereto. Therefore, the NOR circuit 36a serves as a gate circuit of the NAND circuit 36b. An output from each of the switching circuits 36 is output to the level shifter 12f.

The level shifter 12f includes 4n-number of buffer circuits 37 corresponding to the storage circuits 30 as shown in FIG. 6. These buffer circuits 37 are respectively coupled to the write scan lines YW11 to YW1n, YW21 to YW2n, YW31 to YW3n, and YW41 to YW4n. Therefore, the buffer circuits 37 output signals output from the storage circuits 30 corresponding to the circuits 37 to the write scan lines YW11 to YW1n, YW21 to YW2n, YW31 to YW3n, and YW41 to YW4n respectively as write scan signals SCw11 to SCw1n, SCw21 to SCw2n, SCw31 to SCw3n, and SCw41 to SCw4n. At the level shifter 12f, the write scan signals SCw11 to SCw1n select the write scan lines YW11 to YW1n one by one sequentially from top to bottom while the write scan signals SCw21 to SCw2n select the write scan lines YW21 to YW2n one by one sequentially from top to bottom. Similarly, the write scan signals SCw31 to SCw3n select the write scan lines YW31 to YW3n one by one sequentially from top to bottom while the write scan signals SCw41 to SCw4n select the write scan lines YW41 to YW4n one by one sequentially from top to bottom. Consequently, data currents Id1 to Id3m according to image data is written in the pixels 20 coupled to the write scan lines selected.

As shown in FIG. 2, the erase scan driver 13 receives the erase scan driver start pulses SPYE1 to SPYE4, the erase scan driver clock signal CLYE, the inverted erase scan driver clock signal CBYE, and the erase selection signals SELE1 and SELE2 as inputs from the peripheral drive device 2. The erase scan driver 13 includes shift registers 13a to 13d, a selection circuit 13e and a level shifter 13f. The shift register 13a to 13d included in the erase scan driver 13 have structures similar to those of the shift registers 12a to 12d in the write scan driver 12 shown in FIG. 6. Further, the selection circuit 13e and the level shifter 13f included in the erase scan driver 13 have structures similar to those of the selection circuit 12e and the level shifter 12a in the write scan driver 12 shown in FIG. 6. The shift registers 13a to 13d, the selection circuit 13e, and the level shifter 13f operate in the same manner as the shift registers 12a to 12d, the selection circuit 12e, and the level shifter 12f, and therefore the description of their operation is omitted here.

[Data Driver 14]

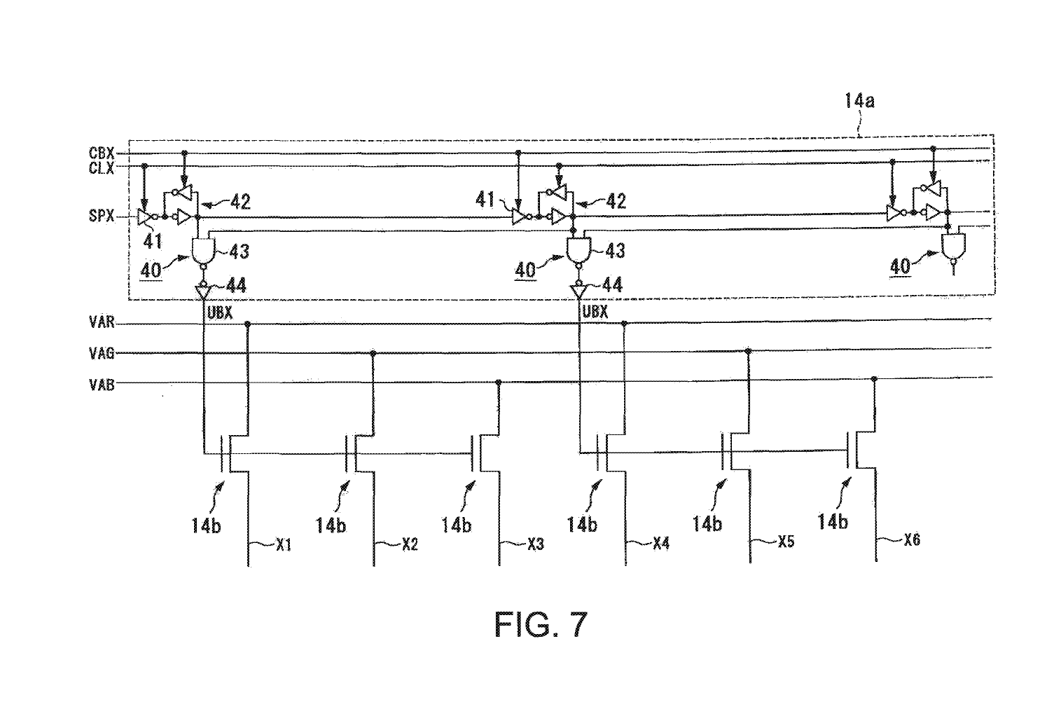

The data driver 14 will now be described. FIG. 7 is a circuit diagram illustrating a structure of the data driver 14 included in the electro-optical device according to the first embodiment of the invention. As shown in the diagram, the data driver 14 receives the data driver start pulse SPX, the data driver clock signal CLX and the inverted data driver clock signal CBX as inputs from the peripheral drive device 2. The data driver 14 also receives the analog image signal VAR for red, the analog image signal VAG for green, and the analog image signal VAB for blue as inputs from the peripheral drive device 2. The data driver 14 then supplies the data currents Id1 to Idm to the data lines X1 to Xm respectively so as to drive the data lines X1 to Xm in sync with the selection of the write scan lines YW11 to YW1n, YW21 to YW2n, YW31 to YW3n, and YW41 to YW4n based on these signals.

Referring to FIG. 7, the data driver 14 includes a shift register 14a and a plurality (3m-number) of transistors 14b. Here, every three data lines out of the 3m-number of data lines X1 to Xm make up a group. The shift register 14a includes 3m-number (i.e. the number of data line groups) of storage circuits 40. Note that FIG. 7 shows only three of the storage circuits 40 for simplifying the description. Each of the storage circuits 40 includes an inverter circuit 41, a latch part 42, a NAND circuit 43, and another inverter circuit 44.

The inverter circuit 41 included in each of the storage circuits 40 in odd-numbered stages receives the data driver clock signal CLX as an input, while the inverter circuit 41 included in each of the storage circuits 40 in even-numbered stages receives the inverted data driver clock signal CBX as an input as synchronizing signals. The inverter circuit 41 of each of the storage circuits 40 in the odd-numbered stages receives the data driver start pulse SPX as an input in response to a rising of the data driver clock signal CLX and outputs the pulse to the latch part 42. The inverter circuit 41 of each of the storage circuits 40 in the even-numbered stages receives the data driver start pulse SPX as an input in response to the rising of the inverted data driver clock signal CBX and outputs the pulse to the latch part 42.

The latch part 42 included in each of the storage circuits 40 is made up of two inverter circuits. The latch part 42 included in each of the storage circuits 40 in the odd-numbered stages receives the inverted data driver clock signal CBX as an input, while the latch part 42 included in each of the storage circuits 40 in the even-numbered stages receives the data driver clock signal CLX as an input as synchronizing signals. The latch part 42 included in each of the storage circuits 40 in the odd-numbered stages receives and retains the data driver start pulse SPX as an input from the inverter circuit 41 in response to the rising of the inverted data driver clock signal CBX. The latch part 42 included in each of the storage circuits 40 in the even-numbered stages receives and retains the data driver start pulse SPX as an input from the inverter circuit 41 in response to the rising of the data driver clock signal CLX. Each latch part 42 outputs the data driver start pulse SPX being retained to the inverter circuit 41 included in the storage circuit 40 of the next stage.

Accordingly, the data driver start pulse SPX at the H level output from the peripheral drive device 2 is sequentially shifted from the storage circuit 40 corresponding to the top three data lines X1 to X3 to the storage circuit 40 corresponding to the bottom three data lines X3m−2 to X3m in sync with the data driver clock signal CLX and the inverted data driver clock signal CBX.

The NAND circuit 43 included in one storage circuit 40 has one input terminal coupled with the output terminal of the latch part 42 and another input terminal coupled with the output terminal of the latch part 42 included in another storage circuit 40 of the next stage. When both the latch parts 42 included in the storage circuit 40 and in the next-stage storage circuit 40 retain the data driver start pulse SPX at the H level, the NAND circuit 43 included in the storage circuit 40 outputs an L-level signal. The NAND circuit 43 outputs an H-level signal when the latch part 42 included in the storage circuit 40 shifts the data driver start pulse SPX. The NAND circuit 43 continues to output the H-level signal until each latch part 42 newly retains the data driver start pulse SPX.

It takes half a period of the data driver clock signal CLX (inverted data driver clock signal CBX) for the signal output from the storage circuit 40 (NAND circuit 43) to rise to the H level after it falls to the L level. The output signal from the NAND circuit 43 included in the storage circuit 40 has its level inverted by the inverter circuit 44 and is then output as an inverted output signal UBX. FIG. 4 shows the inverted output signal UBX from UBX1, UBX2, UBX3 to UBXm−1 and UBXm based on the m-number of NAND circuits 43 shown in FIG. 7 from left to right.

Of the plurality of transistors 14b included in the data driver 14, every three transistors make up a group. Each of the three transistors 14b making up a group has a gate electrode coupled with one inverter circuit 44 included in the shift register 14a. Of the three transistors 14b in each group, a first transistor is coupled with a signal line receiving the analog image signal VAR for red, a second transistor is coupled with a signal line receiving the analog image signal VAG for green and a third transistor is coupled with a signal line receiving the analog image signal VAB for blue. The transistors 14b are also coupled with the data lines X1 to X3m correspondingly.

Accordingly, every time the inverted output signal UBX is output from the shift register 14a, a group of the transistors 14b are sequentially turned on, supplying the analog image signals VAR, VAG, and VAB to three data lines making up a group. For example, when the inverted output signal UBX is output from the inverter circuit 44 on the left in FIG. 7, the three transistors 14b coupled with this inverter circuit 44 are turned on, supplying the analog image signals VAR, VAG, and VAB to the data lines X1, X2, and X3, respectively.

The operation of the organic EL device 1 with the above-described structure will now be described. The CPU included in the peripheral drive device 2 reads image data stored in the main memory unit 5, carries out various types of processing, such as expansion, with the main memory unit 5, and outputs processed data to the graphics controller 6. When receiving image data of one frame, the graphics controller 6 produces the analog image signals VAR, VAG, and VAB for one frame for each of the pixels 20.

The luminance data analysis unit 6b included in the graphics controller 6 calculates a luminance ratio of the image data output from the CPU 4 based on the data. The luminance data analysis unit 6b determines a period during which the organic EL elements 25R, 25G, and 25B are made not emit light (erased) based on the calculated luminance ratio of the image data and data stored in the LUT 7. Upon completion of the above-described process, the graphics controller 6 outputs the analog image signals VAR, VAG, and VAB that have been produced to the VRAM 9, and outputs the data including the determined non-light-emission (erased) period of the organic EL elements 25R, 25G, and 25B as well as the synchronizing signals to the timing controller 8.

The analog image signals VAR, VAG, and VAB are then output to the data driver 14 together with the data driver start pulse SPX, the data driver clock signal CLX and the inverted data driver clock signal CBX. Meanwhile, the write scan driver start pulses SPYW1 to SPYW4, the write scan driver clock signal CLYW, the inverted write scan driver clock signal CBYW, and the write selection signals SELW1 and SELW2 are output to the write scan driver 12, providing a display on the display panel 11.

Upon the selection of the write scan line YW11 caused by the output of the signals, the organic EL elements 25R, 25G, and 25B provided in each of the pixels 20 on this write scan line YW11 start emitting light with identical emission timing. Subsequently, upon the selection of the write scan line YW21, the organic EL elements 25R, 25G, and 25B provided in each of the pixels 20 on this write scan line YW21 start emitting light with identical emission timing. Then, upon the selection of the write scan line YW31 followed by the selection of the YW41, the organic EL elements 25R, 25G, and 25B provided in each of the pixels 20 on the write scan line YW31 start emitting light with identical emission timing and the organic EL elements 25R, 25G, and 25B provided in each of the pixels 20 on the write scan line YW41 start emitting light with identical emission timing.

When drives of the write scan lines YW11, YW21, YW31, and YW41 is completed, the write scan lines YW12 is selected, thereby the organic EL elements 25R, 25G, and 25B provided in each of the pixels 20 on this write scan line YW12 start emitting light with identical emission timing. Then, the write scan lines YW22, YW32, and YW42 are sequentially selected, and in the same manner as above, the write scan lines YW13, YW23, YW33, and YW43, the write scan lines YW14, YW24, YW34, YW44, and so on are driven, the organic EL elements 25R, 25G, and 25B provided in each of the pixels 20 on the write scan lines start emitting light with identical emission timing.

Here, on the display panel 11, the write scan lines YW11 to YW1n, YW21 to YW2n, YW31 to YW3n, and YW41 to YW4n are provided in this order from top to bottom. As described above, these write scan lines are divided into four zones which are the write scan lines YW11 to YW1n, the write scan lines YW21 to YW2n, the write scan lines YW31 to YW3n, and the write scan lines YW41 to YW4n. Therefore, a display area of the display panel 11 is also considered as being divided into four zones. In a case of focusing only on the write scan lines included in one zone, the write scan lines are driven sequentially from top to bottom in the zone independently from other zones. However, in a case of focusing on the whole of the display panel 11, the write scan lines are interlaced by every n-number of the lines from top to bottom, as driven non-sequentially. With such a drive, a non-sequential drive of the write scan lines is facilitated.

While the write scan lines YW11 to YW1n, YW21 to YW2n, YW31 to YW3n, and YW41 to YW4n are being driven, the timing controller 8 in the peripheral drive device 2 outputs the erase scan driver start pulses SPYE1 to SPYE4 together with the erase scan driver clock signal CLYE, the inverted erase scan driver clock signal CBYE, and the erase selection signals SELE1 and SELE2 to the erase scan driver 13 as a predetermined period of time (light-emission period of the organic EL elements 25R, 25G, and 25B) has elapsed since the write scan line YW11 started to be driven, and the erase scan lines corresponding to the write scan lines are driven (non-sequential scan).

In particular, upon the output of the signals above, the erase scan line YE11 is selected first, making the organic EL elements 25R, 25G, and 25B provided in the pixels 20 coupled with this erase scan line YE11 not emit light (cleared). Subsequently, the erase scan line YE21 is selected, making the organic EL elements 25R, 25G, and 25B provided in the pixels 20 coupled with this erase scan line YE21 not emit light (cleared). Then, the erase scan lines YE31 and YE41 are sequentially selected, making the organic EL elements 25R, 25G, and 25B provided in the pixels 20 coupled with the erase scan line YE31 not emit light (cleared) and the organic EL elements 25R, 25G, and 25B provided in the pixels 20 coupled with the erase scan line YE41 not emit light (cleared).

After four of the erase scan lines YE11, YE21, YE31, and YE41 above are driven, the erase scan line YE12 is selected, making the organic EL elements 25R, 25G, and 25B provided in the pixels 20 coupled with this erase scan line YE12 not emit light (cleared). Likewise, after the erase scan lines YE22, YE32, and YE42 are selected sequentially, the erase scan lines YE13, YE23, YE33, and YE43, and the erase scan lines YE14, YE24, YE34, and YE44 are driven, for example, making the organic EL elements 25R, 25G, and 25B provided in each of the pixels 20 coupled with these erase scan lines not emit light (cleared).

A drive of one frame is completed as the above-described process proceeds to the write scan line YW4n, and a drive of the next frame follows. As a predetermined period of time (light-emission period of the organic EL elements 25R, 25G, and 25B) has elapsed since a drive of this frame started, the timing controller 8 in the peripheral drive device 2 outputs the erase scan driver start pulses SPYE1 to SPYE4 together with the erase scan driver clock signal CLYE, the inverted erase scan driver clock signal CBYE, and the erase selection signals SELE1 and SELE2 to the erase scan driver 13 in the same manner as mentioned above. Consequently, the erase scan line YE11 is selected, making the organic EL elements 25R, 25G, and 25B provided in the pixels 20 coupled with this erase scan line YE11 not emit light (cleared). Likewise, the erase scan lines YE21, YE31, and YE41, the erase scan lines YE12, YE22, YE32, and YE42, the erase scan lines YE13, YE23, YE33 and YE43, for example, are selected sequentially in this order, making the organic EL elements 25R, 25G, and 25B provided in each of the pixels 20 coupled with these erase scan lines not emit light (cleared) sequentially.

Accordingly, in this embodiment, the erase scan lines YE11 to YE1n, YE21 to YE2n, YE31 to YE3n, and YE41 to YE4n are non-sequentially driven corresponding to the write scan lines YW11 to YW1n, YW21 to YW2n, YW31 to YW3n, YW41 to YW4n. Similarly to the write scan lines, the erase scan lines are divided into four zones such as the erase scan lines YE11 to YE1n, the erase scan lines YE21 to YE2n, the erase scan lines YE31 to YE3n, and the erase scan lines YE41 to YE4n. Therefore, the erase scan lines are also considered to have the display panel 11 divided into four zones. Accordingly, in a case of focusing only on the erase scan lines included in one zone, the erase scan lines are driven sequentially from top to bottom in the zone independently from other zones. However, in a case of focusing on the whole of the display panel 11, the erase scan lines are interlaced by every n-number of the lines from top to bottom, as driven non-sequentially. With such a drive, a non-sequential drive of the erase scan lines is facilitated.

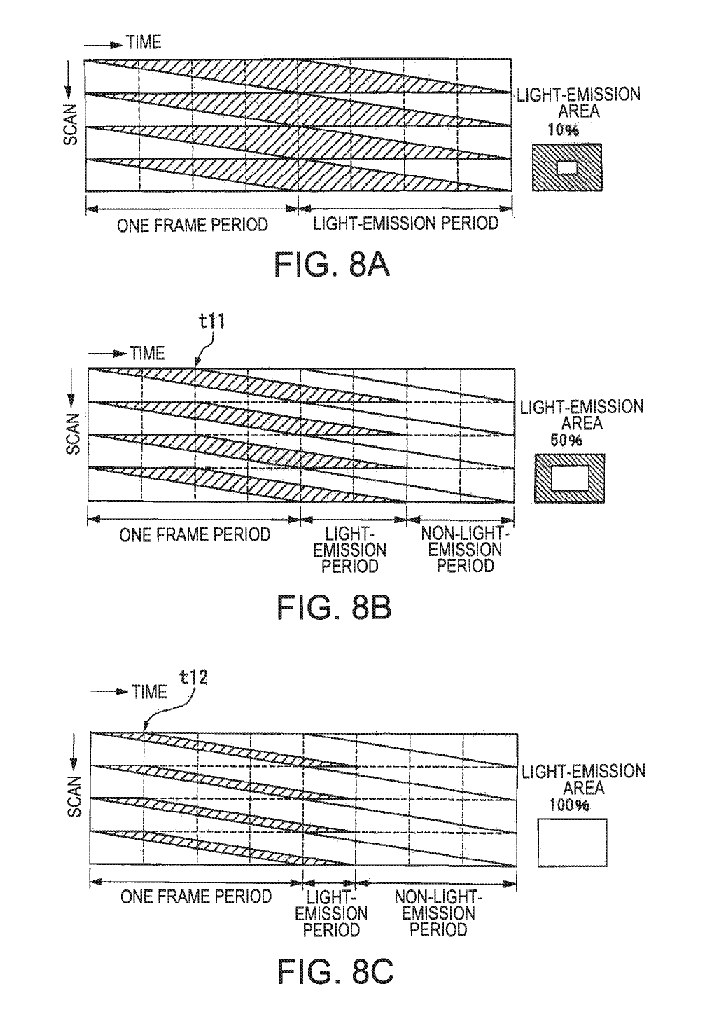

FIGS. 8A through 8C are diagrams for explaining a driving method of the electro-optical device according to the first embodiment of the invention. In these diagrams, the horizontal direction indicates a lapse of time and the vertical direction indicates the scan direction of the scan lines. In the explanation below, when a write scan line and an erase scan line are not necessary to be differentiated, they are referred to as scan lines. FIGS. 8A through 8C show periods for light-emission and non-light-emission of the organic EL elements 25R, 25G, and 25B with a light-emission area of 10%, 50% and 100%, respectively. They schematically show the relationship between an area on which a pixel is provided (display area of the display panel 11) when the light-emission area occupies 10%, 50% and 100% of the display and the light-emission area.

As shown in FIGS. 8A through 8C, the display area of the display panel 11 is divided into four zones in the vertical direction (scan direction). As described above, scan lines included in each zone are driven individually, making the scan lines driven non-sequentially as a whole of the display area of the display panel 11. When the light-emission area occupies 10% as shown in FIG. 8A. The luminance ratio Lr of image data calculated at the luminance data analysis unit 6b is close to zero. Here, the luminance data analysis unit 6b produces a control signal to adjust a light-emission period of the organic EL elements during which the pixels emit light based on the calculated luminance ratio of the image data and data stored in the LUT 7. However, the control signal is not to produce the erase scan driver start pulses SPYE1 to SPYE4. Therefore, the timing controller 8 does not provide the erase scan driver start pulses SPYE1 to SPYE4 to the erase scan driver 13 shown in FIG. 2. As a result, with a 10% light-emission area, each of the organic EL elements 25R, 25G, and 25B included in the pixels on each scan line emits light during one frame. Here, a non-light-emission period for the elements 25R, 25G, and 25B is not set.

Next, when the light-emission area occupies 50% as shown in FIG. 8B, a luminance ratio Lr of image data calculated at the luminance data analysis unit 6b is close to 0.5. Here, the luminance data analysis unit 6b produces a control signal to adjust a light-emission period of the organic EL elements during which the pixels emit light based on the calculated luminance ratio of the image data and data stored in the LUT 7. Here, based on the control signal produced, the timing controller 8 shown in FIG. 1 provides the erase scan driver start pulses SPYE1 to SPYE4 to the erase scan driver 13 shown in FIG. 2 at timing till shown in FIG. 8B. As a result, with a 50% light-emission area, each of the organic EL elements 25R, 25G, and 25B included in the pixels on each scan line emits light during the first half of one frame period, and does not emit light during the second half of the period.

Further, when the light-emission area occupies 100% as shown in FIG. 8C, the luminance ratio Lr of image data calculated at the luminance data analysis unit 6b shown in FIG. 1 is close to one. Here, the luminance data analysis unit 6b produces a control signal to adjust a light-emission period of the organic EL elements during which the pixels emit light based on the calculated luminance ratio of the image data and data stored in the LUT 7. Here, based on the control signal produced, the timing controller 8 shown in FIG. 1 provides the erase scan driver start pulses SPYE1 to SPYE4 to the erase scan driver 13 shown in FIG. 2 at timing t12 shown in FIG. 8C. As a result, with a 100% light-emission area, each of the organic EL elements 25R, 25G, and 25B included in pixels on each scan line emits light during the first predetermined period of one frame period, and does not emit light during the remaining period. In the example shown in FIG. 8C, the non-light-emission period of the organic EL elements 25R, 25G, and 25B is set longer than the light-emission period the elements 25R, 25G, and 25B.

The method according to the present embodiment thus adjusts the non-light-emission timing of the organic EL elements 25R, 25G, and 25B depending on light-emission areas (the luminance ratio of an image to be displayed) to adjust the light-emission period of the elements 25R, 25G, and 25B. Since the voltages (driving voltages VER, VEG, and VEB) are fixed irrespective of light-emission areas, the luminance of the organic EL elements 25R, 25G, and 25B depends on the light-emission period. As a result, the luminance can be controlled in accordance with the luminance ratio of an image to be displayed without changing the voltages (driving voltages VER, VEG, and VEB) applied to the organic EL elements 25R, 25G, and 25B, thereby providing highly contrasted images as CRT displays in related art examples do. Furthermore, since there is no need to change the driving voltages no matter how large the light-emission area is in the embodiment, high controllability of grayscale is available. Furthermore, in the embodiment, as a whole of the display area of the display panel 11, scan lines are driven non-sequentially. Therefore, light-emitting pixels in the display area of the display panel 11 is prevented from being biased (the light-emitting pixels are dispersed), thereby providing a display with high quality achieving flickering reduction.

While the examples of FIGS. 8A through 8C show the 10%, 50% and 100% light-emission areas, it is also possible to control luminance in continuity depending on light-emission areas by setting a non-light-emission period of the organic EL elements 25R, 25G, and 25B depending on light-emission areas. The non-light-emission timing of the organic EL elements 25R, 25G, and 25B is set by the data stored in the LUT 7 shown in FIG. 1. Accordingly, the non-light-emission timing of the elements 25R, 25G, and 25B can be adequately changed simply by changing the data in the LUT without making a major change in the device structure.

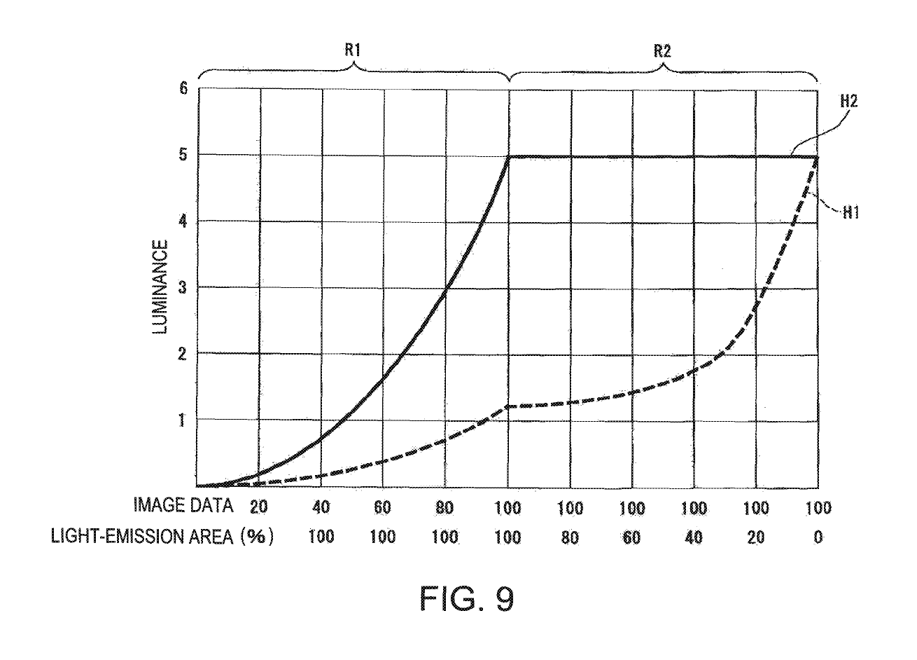

It is desirable that this luminance control depending on light-emission areas provide as high controllability as CRT displays in related art examples do. FIG. 9 is a diagram showing an example of luminance control of a CRT display and a liquid crystal display (LCD). In this diagram, the horizontal direction indicates image data and light-emission area scales and the vertical direction indicates luminance. When the scale of image data shown in the horizontal direction is zero, a dark display is provided. When the scale is 100, a bright display is provided. The diagram can be separated into two graphs. The first graph R1 shows the varying scale of image data from 0 to 100 with a fixed light-emission area of 100%. The second graph R2 shows varying light-emission areas from 100% to 0% with a fixed image data scale of 100. Referring to the graphs, the dashed line H1 represents CRT luminance and the solid line H2 represents LCD luminance.

Referring to the first graph R1 in FIG. 9, both the line H1 representing CRT luminance and the line H2 representing LCD luminance show luminance growth as the scale of image data increases. Referring to the second graph R2, while the line H1 representing CRT luminance shows luminance growth nonlinearly in line with decreasing light-emission areas, the line H2 representing LCD luminance shows a fixed luminance (the luminance when the image data scale is 100). Since electro-optical devices in related art examples do not control luminance according to light-emission areas, light with fixed luminance is emitted irrespective of change of light-emission areas as shown by the line H2 representing LCD luminance.

In this regard, the above-described method for driving the electro-optical device 1 according to the embodiment controls luminance depending on light-emission areas and thus can provide highly contrasted images as a CRT does. To provide as high controllability as a CRT does, it is desirable that luminance be controlled in a way it will change nonlinearly depending on light-emission areas as shown by the line H1 representing CRT luminance in the second graph.

According to the present embodiment, the storage capacitor 22 included in each of the subpixels 20R, 20G, and 20B retains potential for the analog image signals VAR, VAG, and VAB, respectively. The driving TFT 23 is controlled with the potential retained in the storage capacitor 22 so as to control a current flowing into the organic EL elements 25R, 25G, and 25B. Accordingly, variance in characteristics (threshold voltages) of the organic EL elements 25R, 25G, and 25B included in the subpixels 20R, 20G, and 20B, respectively, prevents display in accordance with the analog image signals VAR, VAG, and VAB.

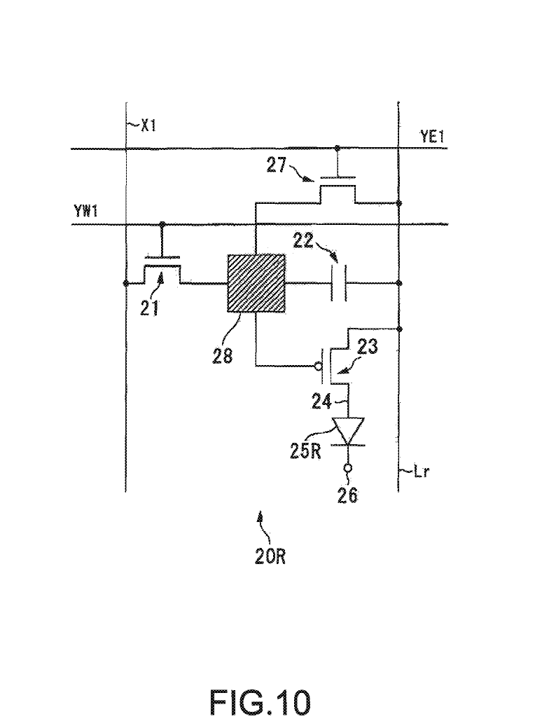

It is therefore desirable that each of the subpixels 20R, 20G, and 20B have the structure shown in FIG. 10. FIG. 10 illustrates another example showing a structure of the subpixel 20R. While only the structure of the subpixel 20R is described here, it is applicable to the subpixels 20G and 20B as well. Referring to the diagram, the subpixel 20R includes a compensation circuit 28 that compensates threshold voltage variance of the driving TFT 23 at the point P1 shown in FIG. 3. The compensation circuit 28 compensates threshold voltage variance of the driving TFT 23 included in each of the subpixels 20R, 20G, and 20B, providing an image display with favorable quality.

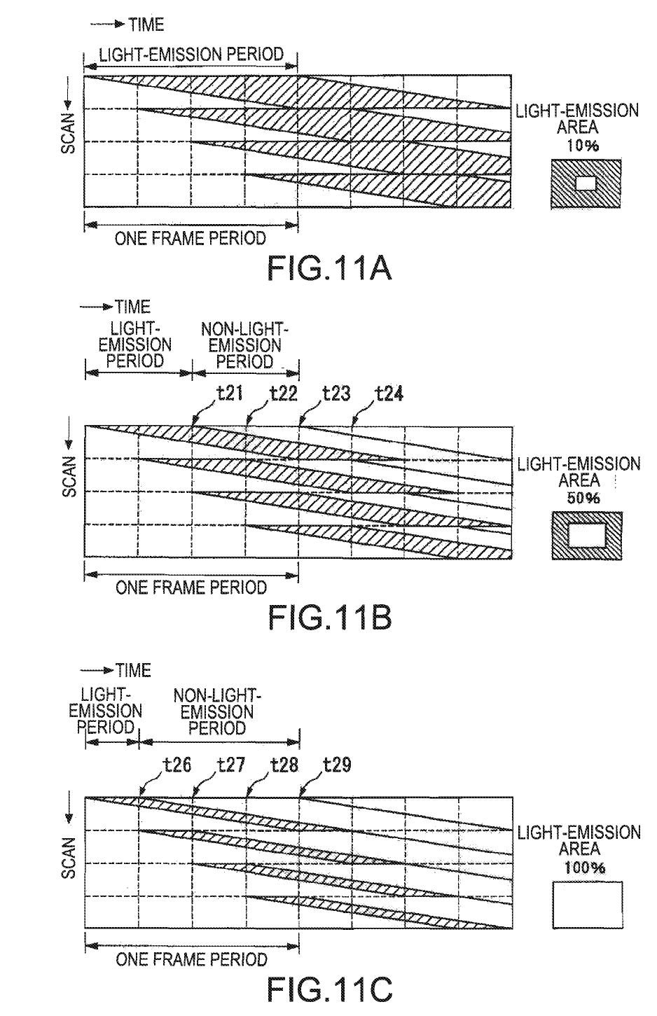

Further, in the embodiment above, the display area of the display panel 11 is divided into four zones in the vertical direction (scan direction), so that the scan lines are driven non-sequentially. However, this structure is also applicable to the time direction by dividing the one frame period into four zones to drive. FIGS. 11A though 11C are diagrams for explaining another example of the driving method of the electro-optical device according to the first embodiment of the invention. In these diagrams, the horizontal direction indicates a lapse of time and the vertical direction indicates the scan direction of the scan lines as in FIGS. 8A through 8C. Further, as in FIGS. 8A through 8C, FIGS. 11A through 11C show periods for light-emission and non-light-emission of the organic EL elements 25R, 25G, and 25B with a light-emission area of 10%, 50% and 100%, respectively.

As shown in FIGS. 11A to 10C, in this driving method, the display area of the display panel 11 is also divided into four zones in the vertical direction (scan direction). As the driving method described with FIGS. 8A through 8C, scan lines included in each zone are driven individually, making the scan lines driven non-sequentially as a whole of the display area of the display panel 11. In addition to the above, scan start timing of each zone divided is shifted by a quarter frame period in the driving method. This is achieved by shifting timing of the write scan driver start pulses SPYW4 to SPYW4 (refer to FIG. 6) respectively input to the shift resisters 12a to 12d provided in the write scan driver 12, and timing of the erase scan driver start pulses SPYE1 to SPYE4 (refer to FIG. 6) respectively input to the shift resisters 13a to 13d provided in the erase scan driver 13.

When the light-emission area occupies 10% as shown in FIG. 11A, the luminance ratio Lr of image data calculated at the luminance data analysis unit 6b in FIG. 1 is close to zero. Here, the luminance data analysis unit 6b produces a control signal to adjust a light-emission period of the organic EL elements during which the pixels emit light based on the calculated luminance ratio of the image data and data stored in the LUT 7. However, the control signal is not to produce the erase scan driver start pulses SPYE1 to SPYE4. Therefore, the timing controller 8 does not provide the erase scan driver start pulses SPYE1 to SPYE4 to the erase scan driver 13 shown in FIG. 2. As a result, with a 10% light-emission area, each of the organic EL elements 25R, 25G, and 25B included in pixels on each scan line emits light during one frame. Here, a non-light-emission period for the elements 25R, 25G, and 25B is not set,.

Next, when the light-emission area occupies 50% as shown in FIG. 11B, the luminance ratio Lr of image data calculated at the luminance data analysis unit 6b in FIG. 1 is close to 0.5. Here, the luminance data analysis unit 6b produces a control signal to adjust a light-emission period of the organic EL elements during which the pixels emit light based on the calculated luminance ratio of the image data and data stored in the LUT 7. Here, based on the control signal produced, the timing controller 8 shown in FIG. 1 provides the erase scan driver start pulses SPYE1 to SPYE4 to the erase scan driver 13 shown in FIG. 2. More specifically, the erase scan driver start pulse SPYE1 is provided at timing t21 shown in FIG. 11B while the erase scan driver start pulse SPYE2 is provided at timing t22 shown in FIG. 11B. Furthermore specifically, the erase scan driver start pulse SPYE3 is provided at timing t23 in FIG. 11B while the erase scan driver start pulse SPYE4 is provided at timing t24 in FIG. 11B. As a result, with a 50% light-emission area, each of the organic EL elements 25R, 25G, and 25B included in pixels on each scan line emits light during the first half of one frame period, and does not emit light during the second half of the period.

Further, when the light-emission area occupies 100% as shown in FIG. 11C, the luminance ratio Lr of image data calculated at the luminance data analysis unit 6b shown in FIG. 1 is close to one. Here, the luminance data analysis unit 6b produces a control signal to adjust a light-emission period of the organic EL elements during which the pixels emit light based on the calculated luminance ratio of the image data and data stored in the LUT 7. Here, based on the control signal produced, the timing controller 8 shown in FIG. 1 provides the erase scan driver start pulses SPYE1 to SPYE4 to the erase scan driver 13 shown in FIG. 2. More specifically, the erase scan driver start pulse SPYE1 is provided at timing t26 shown in FIG. 11C while the erase scan driver start pulse SPYE2 is provided at timing t27 shown in FIG. 11C. Further, the erase scan driver start pulse SPYE3 is provided at timing t28 in FIG. 11C while the erase scan driver start pulse SPYE4 is provided at timing t29 in FIG. 11C. As a result, with a 100% light-emission area, each of the organic EL elements 25R, 25G, and 25B included in pixels on each scan line emits light during the first predetermined period of one frame period, and does not emit light during the remaining period. In the example shown in FIG. 11C, the non-light-emission period of the organic EL elements 25R, 25G, and 25B is set longer than the light-emission period of the elements 25R, 25G, and 25B.

In the driving method to drive shown as above, the light-emission period of the organic EL elements 25R, 25G, and 25B is also adjusted according to light-emission areas (the luminance ratio of an image to be displayed) as the driving method described with FIGS. 8A through 8C. That is, as referred to FIG. 11A, with a 10% light-emission area, each of the organic EL elements 25R, 25G, and 25B included in pixels on each scan line emits light during one frame. Here, a non-light-emission period for the elements 25R, 25G, and 25B is not set. Referring to FIG. 11B, with a 50% light-emission area, each of the organic EL elements 25R, 25G, and 25B included in pixels on each scan line emits light during the first half of one frame. During the second half, the organic EL elements 25R, 25G, and 25B are made not emit light (erased). Referring to FIG. 11C, with a 100% light-emission area, each of the organic EL elements 25R, 25G, and 25B included in pixels on each scan line emits light only during a predetermined period from the beginning of one frame. During the remaining period, the organic EL elements 25R, 25G, and 25B are made not emit light (erased).

By following the method above, light-emitting pixels in the display area of the display panel 11 is prevented from being biased as well as a bias of timing of the light-emitting pixels are dispersed, thereby display adjoining frames is prevented from flickering and thus flickering is effectively prevented from occurring. Further, in the driving method, the non-light-emission timing of the organic EL elements 25R, 25G, and 25B depending on light-emission areas (the luminance ratio of an image to be displayed) is adjusted so as to adjust the light-emission period of the elements 25R, 25G, and 25B, thereby providing highly contrasted images as the as CRT displays in related art examples do. In the embodiment, since the display area of the display panel 11 is divided into four zones in the vertical direction (scan direction), scan start timing in each zone divided is shifted by a quarter frame period. However, a period obtained by dividing one frame period by the number of the zones only can be shifted.

### Second Embodiment

Next, an electro-optical device according to a second embodiment of the invention will be described. In this embodiment, an organic EL device is exemplified as the electro-optical device to describe. The electro-optical device according to the embodiment has almost the same structure as a whole as the electro-optical device of the first embodiment shown in FIG. 1. However, in the electro-optical device according to this embodiment, internal structures of which corresponding to the write scan driver 12 and the erase scan driver 13, and a signal output to which corresponding to the write scan driver 12 and the erase scan driver 13 from the timing controller 8 are different from those in the first embodiment. As for a description below, structural elements common to those of the electro-optical device 1 of the first embodiment are given the same numerals, and differences from the first embodiment will be explained.

[Display Panel Unit 3]

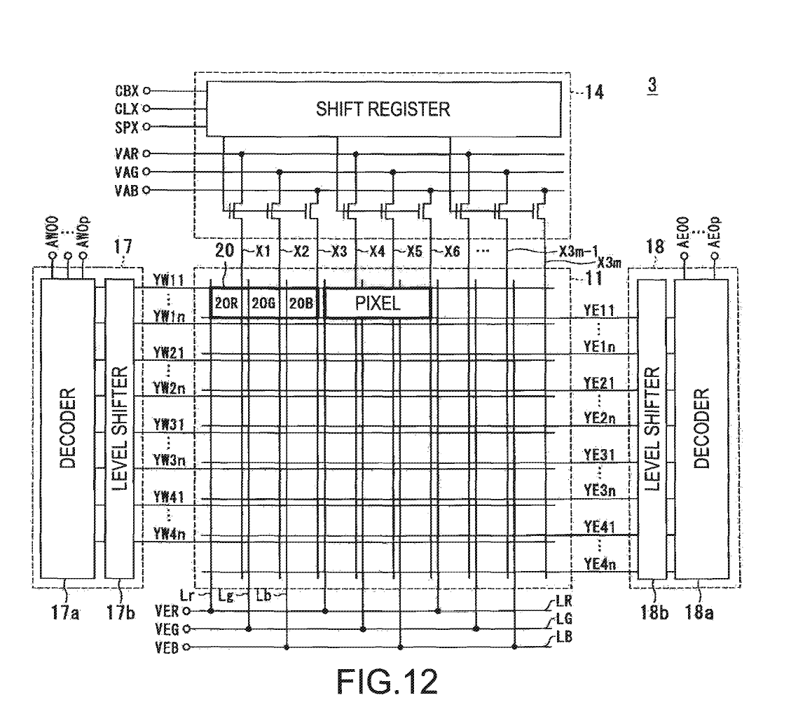

FIG. 12 is a block diagram illustrating the structure of the display panel unit included in the electro-optical device according to the second embodiment of the invention. As shown in FIG. 12, the display panel unit 3 of the embodiment includes a write scan driver 17 instead of the write scan driver 12 in FIG. 2, and an erase scan driver 18 instead of the erase scan driver 13 in FIG. 2. The timing controller 8 in FIG. 1 outputs write scan driver digital code signals AW00 to AW0p to the write scan driver 17 based on the basic clock signal CLK while the timing controller 8 outputs erase scan driver digital code signals AE00 to AE0p to the erase scan driver 18 based on the basic clock signal CLK.

The write scan driver digital code signals AW00 to AW0p are signals to specify a write scan line to drive out of the write scan lines YW11 to YW1n, YW21 to YW2n, YW31 to YW3n, and YW41 to YW4n. The erase scan driver digital code signals AE00 to AE0p are signals to specify an erase scan line to drive out of the erase scan lines YE11 to YE1n, YE21 to YE2n, YE31 to YE3n, and YE41 to YE4n. That is, specifying the write scan driver digital code signals AW00 to AW0p can make an arbitrary write scan line drive, and specifying the erase scan driver digital code signals AE00 to AE0p can make an arbitrary erase scan line drive.

Further, to the data driver 14, the timing controller 8 in FIG. 1 outputs the data driver clock signal CLX, the inverted data driver clock signal CBX, the data driver start pulse SPX, and the analog image signals VAR, VAG, and VAB similarly to the first embodiment.

[Write Scan Driver 17 and Erase Scan Driver 18]

Referring to FIG. 12, the write scan driver 17 includes a decoder 17a and a level shifter 17b. The decoder 17a decodes the write scan driver digital code signals AW00 to AW0p from the timing controller 8, and outputs a signal to drive one of the write scan lines YW11 to YW1n, YW21 to YW2n, YW31 to YW3n, and YW41 to YW4n to the level shifter 17a. The level shifter 17b has the same structure as that of the level shifter 12f shown in FIG. 6, and includes 4n-number of buffer circuits respectively coupled to the write scan lines YW11 to YW1n, YW21 to YW2n, YW31 to YW3n, and YW41 to YW4n. Therefore, the level shifter 17b outputs signals output from the decoder 17a to the write scan lines YW11 to YW1n, YW21 to YW2n, YW31 to YW3n, and YW41 to YW4n respectively as the write scan signals SCw11 to SCw1n, SCw21 to SCw2n, SCw31 to SCw3n, and SCw41 to SCw4n.

Referring to FIG. 12, the erase scan driver 18 includes a decoder 18a and a level shifter 18b. The decoder 18a decodes the erase scan driver digital code signals AE00 to AE0p, and outputs signals to drive one of the erase scan lines YE11 to YE1n, YE21 to YE2n, YE31 to YE3n, and YE41 to YE4n to the level shifter 18b. The level shifter 18b has the same structure as that of the level shifter 12 shown in FIG. 6, and includes 4n-number of buffer circuits respectively coupled to the erase scan lines YE11 to YE1n, YE21 to YE2n, YE31 to YE3n, and YE41 to YE4n. Since the erase scan driver 18 basically operates as same as the write scan driver 17, its detailed description is omitted.

Next, an operation of the electro-optical device with the structure above according to the second embodiment of the invention will be described. Here, in the embodiment, a scan speed of the write scan lines and the erase scan lines is double the scan speed of the first embodiment, and further, each of the scan lines is driven twice in one frame period. First, in the same manner as the first embodiment, the CPU included in the peripheral drive device 2 reads image data stored in the main memory unit 5, carries out various types of processing, such as expansion, with the main memory unit 5, and outputs processed data to the graphics controller 6. When receiving image data of one frame, the graphics controller 6 produces the analog image signals VAR, VAG, and VAB for one frame for each of the pixels 20.

The luminance data analysis unit 6b included in the graphics controller 6 calculates a luminance ratio of the image data output from the CPU 4 based on the image data. The luminance data analysis unit 6b determines a period during which the organic EL elements 25R, 25G, and 25B are made not emit light (erased) based on the calculated luminance ratio of the image data and data stored in the LUT 7. Upon completion of the above-described process, the graphics controller 6 outputs the analog image signals VAR, VAG, and VAB that have been produced to the VRAM 9, and outputs the data including the determined non-light-emission (erased) period of the organic EL elements 25R, 25G, and 25B as well as the synchronizing signals to the timing controller 8.

Then, the analog image signals VAR, VAG, and VAB are output together with the data driver start pulse SPX, the data driver clock signal CLX, and the inverted data driver clock signal CBX to the data driver 17 followed by output of the write scan driver digital code signals AW00 to AW0p to the write scan driver 17 so that the display panel 11 is displayed.

Upon the selection of the write scan line YW11 caused by the output of the signals, the organic EL elements 25R, 25G, and 25B provided in each of the pixels 20 on this write scan line YW11 start emitting light with identical emission timing. Subsequently, upon the selection of the write scan line YW21, the organic EL elements 25R, 25G, and 25B provided in each of the pixels 20 on this write scan line YW21 start emitting light with identical emission timing. Then, upon the selection of the write scan line YW31 followed by the selection of the YW41, the organic EL elements 25R, 25G, and 25B provided in each of the pixels 20 on the write scan line YW31 start emitting light with identical emission timing and the organic EL elements 25R, 25G, and 25B provided in each of the pixels 20 on the write scan line YW41 start emitting light with identical emission timing.

When drives of the write scan lines YW11, YW21, YW31, and YW41 are completed, the write scan line YW12 is selected, thereby the organic EL elements 25R, 25G, and 25B provided in each of the pixels 20 on this write scan line YW12 start emitting light with identical emission timing. Then, the write scan lines YW22, YW32, and YW42 are sequentially selected, and in the same manner as above, the write scan lines YW13, YW23, YW33, and YW43, the write scan lines YW14 YW24, YW34, YW44 and so on are driven, the organic EL elements 25R, 25G, and 25B provided in each of the pixels 20 on the write scan line YW31 start emitting light with identical emission timing and the organic EL elements 25R, 25G, and 25B provided in each of the pixels 20 on the write scan lines start emitting light.

Here, although an arbitrary write scan line can be driven by specifying the write scan driver digital code signals AW00 to AW0p, the write scan lines in this case is driven in the same order as that of the first embodiment. In a case of focusing only on the write scan lines included in one zone out of four zones such as the write scan lines YW11 to YW1n, YW21 to YW2n, YW31 to YW3n, and YW41 to YW4n in the display panel 11, the write scan lines are driven sequentially from top to bottom in the zone independently from other zones. However, in a case of focusing on the whole of the display panel 11, the write scan lines are interlaced by every n-number of the lines from top to bottom, as driven non-sequentially. In this embodiment, as it is considered that the scan speed is double the scan speed of the first embodiment, it should be noted that each of the write scan lines are driven at a double speed.

While the write scan lines YW11 to YW1n, YW21 to YW2n, YW31 to YW3n, and YW41 to YW4n are being driven, the timing controller 8 in the peripheral drive device 2 outputs the erase scan driver digital code signals AE00 to AE0p to the erase scan driver 13 as a predetermined period of time (light-emission period of the organic EL elements 25R, 25G, and 25B) has elapsed since the write scan line YW11 started to be driven, and the erase scan lines corresponding to the write scan lines are driven (non-sequential scan).

In particular, upon the output of the erase scan driver digital code signals AE00 to AE0p above, the erase scan line YE11 is selected first, making the organic EL elements 25R, 25G, and 25B provided in the pixels 20 coupled with this erase scan line YE11 not emit light (cleared). Subsequently, the erase scan line YE21 is selected, making the organic EL elements 25R, 25G, and 25B provided in the pixel 20 coupled with this erase scan line YE21 not emit light (cleared). Then, the erase scan lines YE31 and YE41 are sequentially selected, making the organic EL elements 25R, 25G, and 25B provided in the pixel 20 coupled with the erase scan line YE31 not emit light (cleared) and the organic EL elements 25R, 25G, and 25B provided in the pixels 20 coupled with the erase scan line YE41 not emit light (cleared).

After four of the erase scan line YE11, YE21, YE31, and YE41 are driven, the erase scan line YE12 is selected, making the organic EL elements 25R, 25G, and 25B provided in the pixels 20 coupled with this erase scan line YE12 not emit light (cleared). Likewise, after the erase scan lines YE22, YE32, and YE42 are selected sequentially, the erase scan lines YE13, YE23, YE33, and YE43, and the erase scan lines YE14, YE24, YE34, YE44 and so on are driven, making the organic EL elements 25R, 25G, and 25B provided in each of the pixels 20 coupled with these erase scan lines not emit light (cleared).

A half frame is completely scanned with completion of driving the write scan line YW4n described above, and then the second half starts to be driven. As a predetermined period of time (light-emission period of the organic EL elements 25R, 25G, and 25B) has elapsed since driving of this half frame started, the timing controller 8 in the peripheral drive device 2 outputs the erase scan driver digital code signal AE00 to AE0p to the erase scan driver 13 in the same manner as mentioned above. Consequently, the erase scan line YE11 is selected, making the organic EL elements 25R, 25G, and 25B provided in the pixels 20 coupled with this erase scan line YE11 not emit light (cleared).

Likewise, the erase scan lines YE21, YE31, and YE41, the erase scan lines YE12, YE22, YE32, and YE42, the erase scan lines YE13, YE23, YE33 and YE43 and so on are selected sequentially in this order, making the organic EL elements 25R, 25G, and 25B provided in each of the pixels 20 coupled with these erase scan lines not emit light (cleared) sequentially. Accordingly, in this embodiment, the erase scan lines YE11 to YE1n, YE21 to YE2n, YE31 to YE3n, and YE41 to YE4n are non-sequentially driven corresponding to the write scan lines YW11 to YW1n, YW21 to YW2n, YW31 to YW3n, and YW41 to YW4n in the same manner as the first embodiment. Accordingly, likewise the first embodiment, non-sequential drives of the write scan lines and the erase scan lines are facilitated.

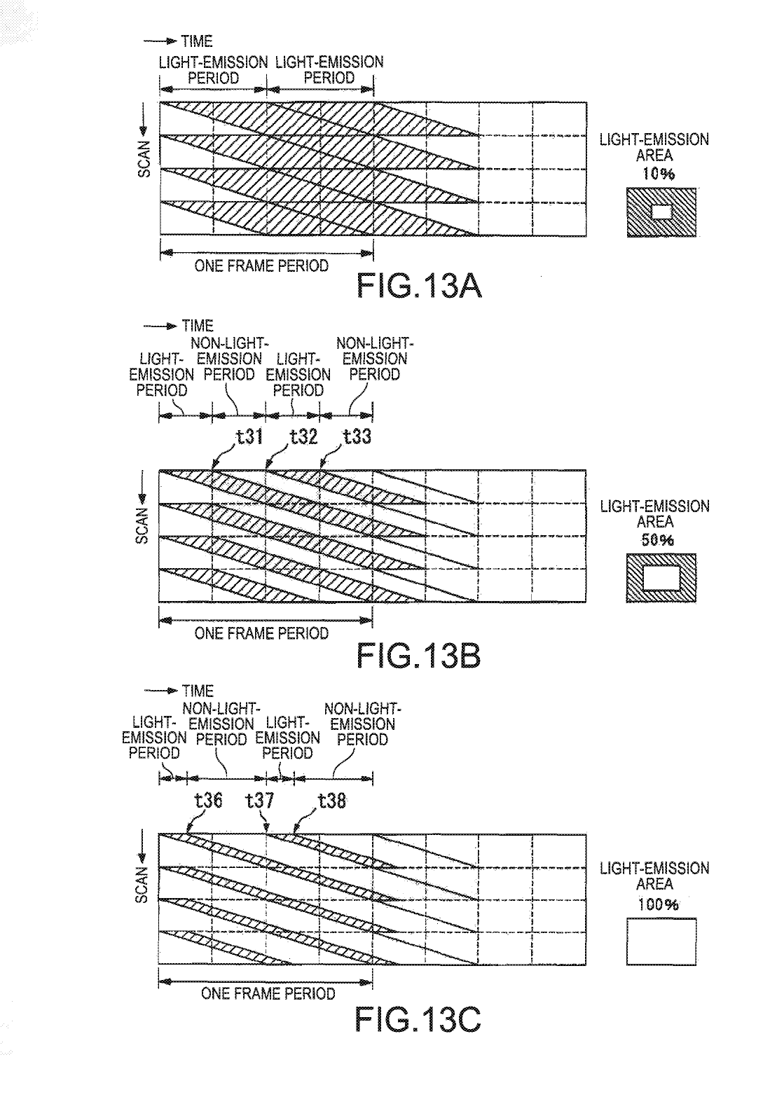

FIGS. 13A through 13C are diagrams for explaining a method for driving the electro-optical device according to the second embodiment of the invention. In these diagrams, the horizontal direction indicates a lapse of time and the vertical direction indicates the scan direction of the scan lines as in FIGS. 8A through 8C. FIGS. 13A through 13C show periods for light-emission and non-light emission of the organic EL elements 25R, 25G, and 2513 with a light-emission area of 10%, 50% and 100%, respectively. They schematically show the relationship between an area on which a pixel is provided (display area of the display panel 11) when the light-emission area occupies 10%, 50% and 100% of the display and the light-emission area.

As shown in FIGS. 13A to 13G, the display area of the display panel 11 is divided into four zones in the vertical direction (scan direction). Scan lines included in each zone are driven individually, making the scan lines driven non-sequentially as a whole of the display area of the display panel 11. Further, in the embodiment, the scan speed is double the scan speed in the first embodiment. Therefore, time to drive all the scan lines in each zone is a half of one frame period.

When the light-emission area occupies 10% as shown in FIG. 13A, the luminance ratio Lr of image data calculated at the luminance data analysis unit 6b in FIG. 1 is close to zero. Here, the luminance data analysis unit 6b produces a control signal to adjust a light-emission period of the organic EL elements during which the pixels emit light based on the calculated luminance ratio of the image data and data stored in the LUT 7. However, the control signal is not to produce the erase scan driver digital code signals AE00 to AE0p. Therefore, the timing controller 8 does not provide the erase scan driver digital code signals AE00 to AE0p to the erase scan driver 18 shown in FIG. 12. As a result, with a 10% light-emission area, each of the organic EL elements 25R, 25G, and 25B included in pixels on each scan line emits light during one frame. Here, a non-light-emission period for the elements 25R, 25G, and 25B is not set.

Next, when the light-emission area occupies 50% as shown in FIG. 13B, the luminance ratio Lr of image data calculated at the luminance data analysis unit 6b in FIG. 1 is close to 0.5. Here, the luminance data analysis unit 6b produces a control signal to adjust a light-emission period of the organic EL elements during which the pixels emit light based on the calculated luminance ratio of the image data and data stored in the LUT 7. Based on the control signal produced here, the timing controller 8 shown in FIG. 1 provides the erase scan driver digital code signals AE00 to AE0p to the erase scan driver 18 shown in FIG. 12 at timing t31 shown in FIG. 13B.

Further, after the erase scan driver digital code signal AE00 to AE0p are provided at the timing t31 shown in FIG. 13B, the timing controller 8 in FIG. 1 outputs the write scan driver digital code signal AW00 to AW0p to the write scan driver 17 in FIG. 12 at timing t32 shown in FIG. 13B. Afterward, the timing controller 8 shown in FIG. 1 provides the erase scan driver digital code signals AE00 to AE0p to the erase scan driver 18 shown in FIG. 12 at timing t33 shown in FIG. 13B. As a result, with a 50% light-emission area, each of the organic EL elements 25R, 25G, and 25B included in pixels on each scan line emits light during a first half of the first half of one frame period, and does not emit light during a second half of the second half of the period. That is, each of the organic EL elements emits light during a first quarter frame period from the beginning of the first half frame period, and during a quarter frame period from the beginning of the second half frame period.

Further, when the light-emission area occupies 100% as shown in FIG. 13C, the luminance ratio Lr of image data calculated at the luminance data analysis unit 6b shown in FIG. 1 is close to one. Here, the luminance data analysis unit 6b produces a control signal to adjust a light-emission period of the organic EL elements during which the pixels emit light based on the calculated luminance ratio of the image data and data stored in the LUT 7. Based on the control signal produced here, the timing controller 8 shown in FIG. 1 provides the erase scan driver digital code signals AE00 to AE0p to the erase scan driver 18 shown in FIG. 12 at timing t36 shown in FIG. 13C.

Further, after the erase scan driver digital code signals AE00 to AE0p are provided at the timing t36 shown in FIG. 13C, the timing controller 8 in FIG. 1 outputs the write scan driver digital code signals AW00 to AW0p to the write scan driver 17 in FIG. 12 at timing t37 shown in FIG. 13C. Afterward, the timing controller 8 shown in FIG. 1 provides the erase scan driver digital code signals AE00 to AE0p to the erase scan driver 18 shown in FIG. 12 at timing t38 shown in FIG. 13C. As a result, with a 100% light-emission area, each of the organic EL elements 25R, 25G, and 25B included in pixels on each scan line emits light only during a predetermined period from the beginning of the first half and the second half of the one frame period, and does not emit light during the remaining period. In the example shown in FIG. 13C, the non-light-emission period of the organic EL elements 25R, 25G, and 25B is set longer than the light-emission period the elements 25R, 25G, and 25B.

As shown above, in the embodiment, the scan speed of the scan lines is double the scan speed of the first embodiment, and further, each of the scan lines is driven twice in one frame period. However, either the first drive or the second drive for each scan line is a non-sequential drive similarly to the first embodiment. Further, at each of the first drive and the second drive, the non-light-emission timing of the organic EL elements 25R, 25G, and 25B is adjusted depending on light-emission areas (the luminance ratio of an image to be displayed) so as to adjust the light-emission period of the elements 25R, 25G, and 25B. Therefore, the luminance can be controlled depending on the luminance ratio of an image to be displayed without changing the voltages (driving voltages VER, VEG, and VEB) applied to the organic EL elements 25R, 25G, and 25B, thereby providing highly contrasted images as CRT displays in related art examples do. Furthermore, since there is no need to changing the driving voltages no matter how large the light-emission area in the present embodiment, high controllability of grayscale is available. Further, in the embodiment, as a whole of the display area of the display panel 11, the scan lines are driven non-sequentially and driven twice during one frame period, improving dispersion of light-emitting pixels in the display area of the display panel. As a result, a high quality display with less flickering occurrence is achieved.

While the examples of FIGS. 13A through 13C show the 10%, 50% and 100% light-emission areas, it is also possible to control luminance in continuity depending on light-emission areas by setting a non-light-emission period of the organic EL elements 25R, 25G, and 25B depending on light-emission areas. The non-light-emission timing of the organic EL elements 25R, 25G, and 25B is set by the data stored in the LUT 7 shown in FIG. 1. Accordingly, the non-light-emission timing of the elements 25R, 25G, and 25B can be adequately changed simply by changing the data in the LUT without making a major change in the device structure. In addition, it is desirable in this embodiment as well that luminance be controlled nonlinearly depending on light-emission areas as shown by the line H1 representing CRT luminance in FIG. 9. In this embodiment, a case where scan lines are driven twice during one frame period is exemplified to describe, however, the number of scan during one frame period is arbitrary.

In the embodiment described above, an example in which the power lines Lr, Lg, and Lb extending from lower edge to upper edge of the display panel 11 are formed on the display panel 11 is described as shown in FIGS. 2 and 12. However, the power lines Lr, Lg, and Lb formed on the display panel 11 can have a structure other than this. For example, the power lines Lr, Lg, and Lb shown in FIGS. 2 and 12 can be divided in the center of the display panel in an up and down direction, and the power supply lines LR, LG, and LB to be connected to the power lines divided and located on the upper half of the display panel can be formed on the upper edge of the display panel 11. By having such a structure, a voltage drop caused by the power lines Lr, Lg, and Lb is reduced, thereby reducing power consumption.

As the above, the electro-optical device according to the first and second embodiments of the invention is described. However, the invention is not limited to the above embodiments, and can be freely varied within the scope of the invention. For example, in the aforementioned embodiments, the timing to write the analog image signals VAR, VAG, and VAB to each pixel provided to the data lines X1 to X3m by driving the write scan lines YW11 to YW1n, YW21 to YW2n, YW31 to YW3n, and YW41 to YW4n, equals to the timing to make the organic EL elements 25R, 25G, and 25B formed on each pixel emit light.

However, the timing to write the analog image signals VAR, VAG, and VAB to each pixel can be set in different timing from that to emit the organic EL elements 25R, 25G, and 25B formed on each pixel. Then after the analog image signals VAR, VAG and VAB are written, the organic EL elements 25R, 25G, and 25B formed on pixels in which the analog image signals VAR, VAG, and VAB are written can emit light all together. Then, when luminance depending on the luminance ratio of an image to be displayed is controlled, the organic EL elements 25R, 25G, and 25B emitting light can be non-emissive all together according to the luminance ratio.

### Third Embodiment

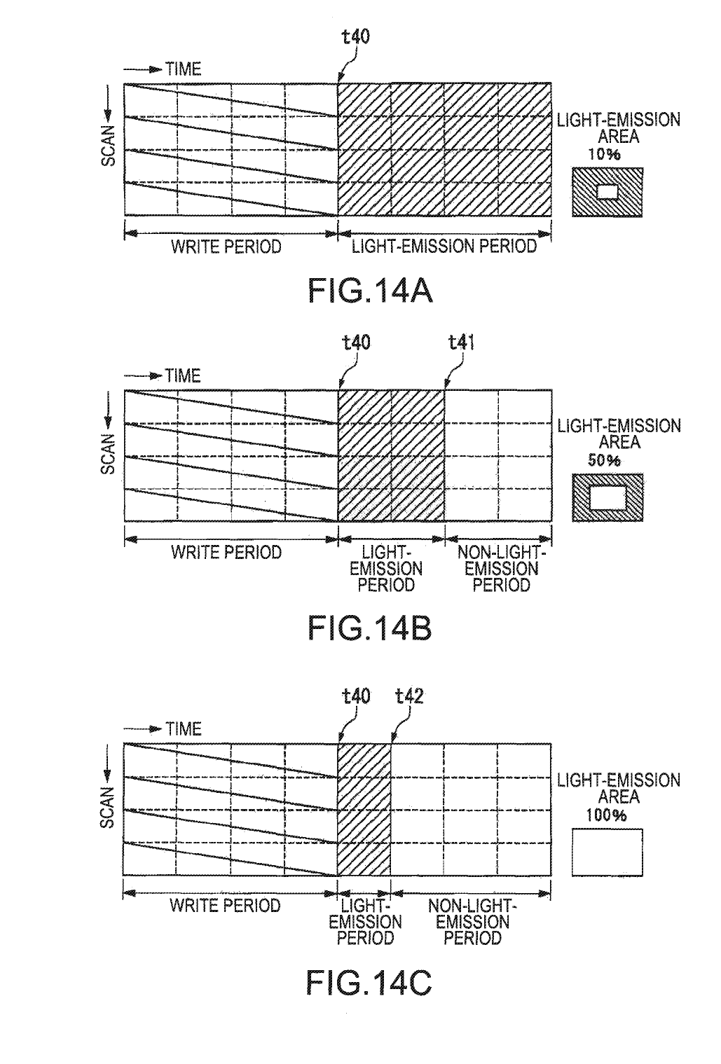

FIGS. 14A through 14C are diagrams for explaining a method for driving an electro-optical device according to a third embodiment of the invention. In these diagrams, the horizontal direction indicates a lapse of time and the vertical direction indicates the scan direction of the scan lines as those in FIGS. 8A through 8C. FIGS. 14A through 14C show periods for light-emission and non-light-emission of the organic EL elements 25R, 25G, and 25B with a light-emission area of 10%, 50% and 100%, respectively. They schematically show the relationship between an area on which a pixel is provided (display area of the display panel 11) when the light-emission area occupies 10%, 50% and 100% of the display and the light-emission area.

As shown in FIGS. 14A through 14C, in this embodiment, a write period to write the analog image signals VAR, VAG, and VAB to each pixel by driving the write scan lines YW11 to YW1n, YW21 to YW2n, YW31 to YW3n, and YW41 to YW4n, and a control period to control light-emission and non-light-emission states of the organic EL elements 25R, 25G, and 25B are set. In FIGS. 14A through 14C, the write period and the control period to control light-emission and non-light-emission states of the organic EL elements 25R, 25G, and 25B are shown in the same lengths. However, to prevent flickering, it is desirable to shorten the write period to the utmost extent.

Further, the display area of the display panel 11 is divided into four zones in the vertical direction (scan direction). Upon the write period, scan lines included in each zone are driven individually, making the scan lines driven non-sequentially as a whole of the display area of the display panel 11. After the write period is completed, the control period to control light-emission and non-light-emission of the organic EL elements 25R, 25G, and 2513 is started, making the organic EL elements 25R, 25G, and 25B emit light all together, that are formed on pixels having the analog image signals VAR, VAG, and VAB written. In the example shown in FIGS. 14A through 14C, the organic EL elements 25R, 25G, and 25B emit light all together at timing t40.

When the light-emission area occupies 10% as shown in FIG. 14A, the luminance ratio Lr of image data calculated at the luminance data analysis unit 6b in FIG. 1 is close to zero. Here, the luminance data analysis unit 6b produces a control signal to adjust a light-emission period of the organic EL elements during which the pixels emit light based on the calculated luminance ratio of the image data and data stored in the LUT 7. However, the control signal is not to make the organic EL elements 25R, 25G, and 25B emit light. As a result, with a 10% light-emission area, each of the organic EL elements 25R, 25G, and 25B included in pixels on each scan line emits light during the light-emission period shown in FIG. 14A. Here, a non-light-emission period for the elements 25R, 25G, and 25B is not set.

Next, when the light-emission area occupies 50% as shown in FIG. 141B, the luminance ratio Lr of image data calculated at the luminance data analysis unit 6b in FIG. 1 is close to 0.5. Here, the luminance data analysis unit 6b produces a control signal to adjust a light-emission period of the organic EL elements during which the pixels emit light based on the calculated luminance ratio of the image data and data stored in the LUT 7. Based on the control signal, a signal not to make the organic EL elements 25R, 25G, and 25B emit light is provided at timing t41 shown in FIG. 14B, the organic EL elements 25R, 25G, and 25B do not emit light. As a result, with a 5% light-emission area, each of the organic EL elements 25R, 25G, and 25B included in pixels on each scan line emits light during the first half of the period to control light-emission and non-light-emission shown in FIG. 14B, and does not emit light during the second half of the period.

Further, when the light-emission area occupies 100% as shown in FIG. 14C, the luminance ratio Lr of image data calculated at the luminance data analysis unit 6b shown in FIG. 1 is close to one. Here, the luminance data analysis unit 6b produces a control signal to adjust a light-emission period of the organic EL elements during which the pixels emit light based on the calculated luminance ratio of the image data and data stored in the LUT 7. Based on the control signal, a signal not to make the organic EL elements 25R, 25G, and 25B emit light is provided at timing t42 shown in FIG. 14C, the organic EL elements 25R, 25G, and 25B do not emit light. As a result, with a 100% light-emission area, each of the organic EL elements 25R, 25G, and 25B included in pixels connected to each scan line emits light during a first predetermined period in the period to control light-emission and non-light-emission, and does not emit light during the remaining period. In the example shown in FIG. 14C, the non-light-emission period of the organic EL elements 25R, 25G, and 25B is set longer than the light-emission period of the elements 25R, 25G, and 25B.

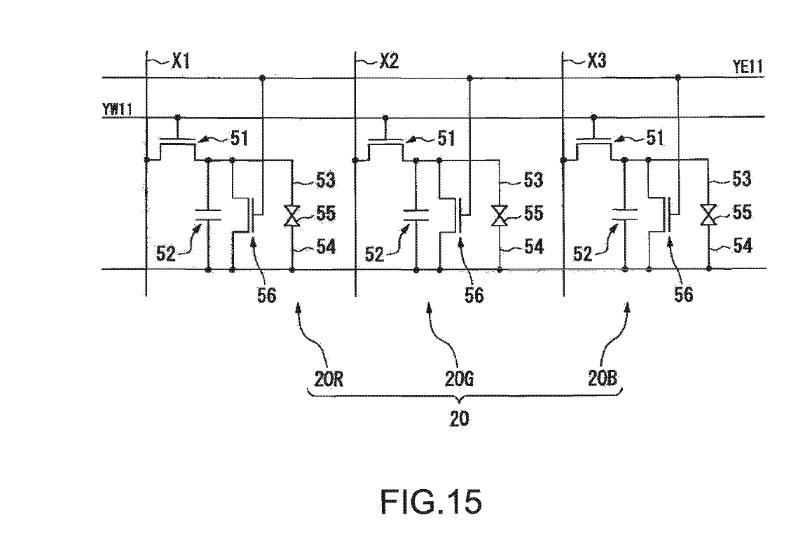

Further, in the embodiment described above, a case where an electro-optical device is an organic EL device is described. However, this invention is also applicable to a case where an electro-optical device is a liquid crystal display. A detailed structure of the liquid crystal display is the same as that of the organic EL device 1 shown in FIGS. 1 and 2. However, the power supply lines LR, LG, and LB are removed from the display panel unit 3 shown in FIG. 2, and each of the pixels 20 (the subpixels 20R, 20G, and 20B) is made to have a structure shown in FIG. 15.

FIG. 15 is a circuit diagram illustrating the structure of the pixels 20 in a case where the electro-optical device is a liquid crystal display according to the embodiment of the invention. FIG. 15 shows one of the pixels 20 on the upper left corner of the display panel 11 as FIG. 3. Structural elements that are the same as the ones in FIG. 3 are given the same numerals. As shown in the diagram, the pixel 20 on the upper left corner of the display panel 11 includes the subpixel 20R emitting red light, the subpixel 20G emitting green light, and the subpixel 20B emitting blue light. Here, the subpixels 20R, 20G, and 20B shown in FIG. 15 do not emit red light, blue light, and green light respectively. The red light, blue light, and green light are emitted by light transmitting liquid crystal and passing through color filters, which are not shown. The other pixels included in the display panel 11 also have the structure made up of the subpixels 20R, 20G, and 20B described below.

The subpixel 20R includes a switching thin-film transistor (TFT) 51 whose gate electrode receives a write scan signal via the write scan line YW11, a storage capacitor 52 retaining a pixel signal supplied from the data line X1 via the switching TFT 51, a pixel electrode 53 to apply a voltage of the pixel signal retained by the storage capacitor 52, and a liquid crystal 55 interposed between the pixel electrode 53 and a counter electrode 54. The liquid crystal 55 can change a light transmission amount depending on a voltage applied between the pixel electrode 53 and the counter electrode 54. In addition, another switching TFT 56 having a gate electrode that receives an erase scan signal via the erase scan line YE11, a source electrode coupled to the pixel electrode 53, and a drain electrode coupled to the counter electrode 54 is also provided.

The subpixel 20G includes a switching thin-film transistor (TFT) 51 whose gate electrode receives a write scan signal via the write scan line YW11, the storage capacitor 52 retaining a pixel signal supplied from the data line X2 via this switching TFT 51, the pixel electrode 53 to apply a voltage of the pixel signal retained by the storage capacitor 52, and the liquid crystal 55 interposed between the pixel electrode 53 and the counter electrode 54. The liquid crystal 55 can change a light transmission amount depending on a voltage applied between the pixel electrode 53 and a counter electrode 54. In addition, the switching TFT 56 having a gate electrode that receives an erase scan signal via the erase scan line YE11, a source electrode coupled to the pixel electrode 53, and a drain electrode coupled to the counter electrode 54 is also provided.

In addition, the switching TFT 56 whose gate electrode receives an erase scan signal via the erase scan line YE11 and a drain electrode is coupled to the counter electrode 54 is also provided. In the same manner, the subpixel 20B includes the TFT 51 whose gate electrode receives a write scan signal via the write scan line YW11, the storage capacitor 52 retaining a pixel signal supplied from the data line X3 via this switching TFT 51, the pixel electrode 53 to apply a voltage of the pixel signal retained by the storage capacitor 52, and the liquid crystal 55 interposed between the pixel electrode 53 and the counter electrode 54. The liquid crystal 55 can change a light transmission amount depending on a voltage applied between the pixel electrode 53 and the counter electrode 54. In addition, the switching TFT 56 having a gate electrode that receives an erase scan signal via the erase scan line YE11, a source electrode coupled to the pixel electrode 53, and a drain electrode coupled to the counter electrode 54 is also provided.

With the pixels 20 described above, when the write scan line YW11 is driven to turn on the switching TFT 51, potential of the data lines X1, X2, and X3 at this time is stored in the storage capacitors 52 included in the subpixels 20R, 20G, and 20B. Then, a transmission amount of the liquid crystal 55 formed in each of the subpixels 20R, 20G, and 20B is changed depending on the state of each of the storage capacitors 52. As a result, light according to the transmission amount is emitted from the subpixels 20R, 20G, and 20B. Further, when the write scan line YW11 is not driven, but the erase scan line YE11 is driven, the switching TFT 56 formed on each of the subpixels 20R, 20G, and 20B are turned on. As a result, the pixel electrode 53 and the counter electrode 54 are at the same potential by being short-circuited. Consequently, transmittance of the liquid crystal 55 formed on each of the subpixels 20R, 20G, and 20B becomes extremely small, thereby the subpixels 20R, 20G, and 20B become non-light-emissive (in a off state).

In the liquid crystal device having the structure described above, timing not to emit light for each of the pixels 20 (subpixels 20R, 20G, and 20B) is adjusted according to light-emission area (luminance ratio of an image) in the same manner as the first and the second embodiments, thereby providing highly contrasted images as CRT displays in related art examples do. Further, by driving scan lines non-sequentially, light-emitting pixels in the display area of the display panel 11 is prevented from being biased (the light-emitting pixels are dispersed), thereby providing a display with high quality achieving flickering reduction.

[Electronic Apparatus]

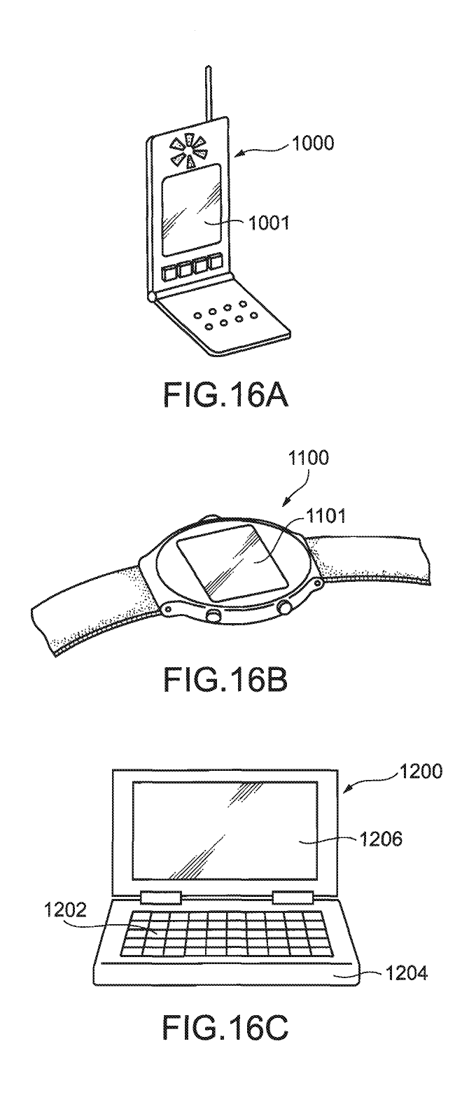

Examples of electronic apparatuses according to the invention will now be described. The electronic apparatuses include the electro-optical device as a display and are illustrated by examples shown in FIGS. 16A through 16C. FIGS. 16A through 16C are diagrams illustrating examples of the electronic apparatuses. FIG. 16A is a perspective view showing an example of cellular phones. Referring to the drawing, this cellular phone 1000 includes a display 1001 using the electro-optical device described above. FIG. 16B is a perspective view showing an example of wristwatch type electronic apparatuses. Referring to the drawing, this watch 1100 includes a display 1101 using the electro-optical device described above. FIG. 16C is a perspective view showing an example of portable information processors, such as word processors and computers. Referring to the drawing, this information processor 1200 includes an input unit 1202, such as a keyboard, a display 1206 using the electro-optical device described above, and an information processor body (case) 1204. The examples shown in FIGS. 16A, 16B, and 16C including the displays 1001, 1101, and 1206, respectively, using the electro-optical device can provide quality display characteristics.

The electro-optical device of the above-described embodiments is also applicable to various electronic apparatuses including viewers, game machines and other portable information terminals, electronic books and electronic paper. In addition, the electro-optical device can be applied to various sorts of electronic equipment such as a video camera, a digital camera, a car navigation, a mobile stereo, an operation panel, a personal computer, a printer, a scanner, a television, a video player, or the like.

What is claimed is:

1. An electro-optical device, comprising:
a plurality of pixels;
a plurality of write scan lines including a predetermined number of the plurality of pixels as a unit; and
a drive device driving the plurality of write scan lines non-sequentially and adjusting a light-emission period of the plurality of pixels in accordance with a luminance ratio of an image.

2. An electro-optical device, comprising:
a plurality of pixels; and
a drive device adjusting a light-emission period of the plurality of pixels in accordance with a luminance ratio of an image.

3. The electro-optical device according to claim 2, wherein the electro-optical device is an organic electroluminescent (EL) device having a light-emitting element included in each of the plurality of pixels.

4. The electro-optical device according to claim 2, wherein the electro-optical device is a liquid crystal device including:
the plurality of pixels each having a pixel electrode;
a counter electrode; and
a liquid crystal interposed between the pixel electrode and the counter electrode.

5. The electro-optical device according to claim 2, wherein the drive device adjusts non-light-emission timing of the plurality of pixels so as to adjust the light-emission period of the plurality of pixels.

6. The electro-optical device according to claim 1, further comprising:
a plurality of erase scan lines formed corresponding to the plurality of write scan lines; and
a plurality of data lines formed with respect to the predetermined number of the plurality of pixels and extending in a direction intersecting with the plurality of write scan lines and the plurality of erase scan lines, wherein the drive device makes the plurality of pixels emit light via the plurality of write scan lines and not emit light via the plurality of erase scan lines.

7. The electro-optical device according to claim 6, wherein the drive device drives the plurality of erase scan lines non-sequentially in response to a driving of the plurality of write scan lines.

8. The electro-optical device according to claim 6, wherein the plurality of write scan lines are divided into zones every predetermined number as a unit in a sequential order and individually driven with respect to each zone by the drive device so as to be driven non-sequentially.

9. The electro-optical device according to claim 8, wherein the plurality of erase scan lines are divided into zones corresponding to the zones of the plurality of write scan lines and individually driven with respect to each zone by the drive device so as to be driven non-sequentially.

10. The electro-optical device according to claim 9, wherein the drive device shifts scan start timing of the plurality of write scan lines and scan start timing of the plurality of erase scan lines by a time period obtained by dividing a predetermined period by the number of zones, the plurality of write scan lines and the plurality of erase scan lines being driven independently with respect to each zone.

11. The electro-optical device according to claim 9, wherein the drive device drives each of the plurality of write scan lines and the plurality of erase scan lines a plurality of times during a predetermined period by driving the plurality of write scan lines and the plurality of erase scan lines during each period obtained by dividing the predetermined period into a plurality of periods.

12. The electro-optical device according to claim 11, wherein the drive device adjusts the light-emission period of the plurality of pixels during each period obtained by dividing the predetermined period into the plurality of periods.

13. The electro-optical device according to claim 6, wherein each of the plurality of pixels includes a drive element making each of the plurality of pixels emit light based on a signal from the plurality of write scan lines and the plurality of data lines, and a compensation circuit compensating variance of a characteristic of the drive element.

14. The electro-optical device according to claim 2, wherein the plurality of pixels include a red pixel emitting red light, a green pixel emitting green light, and a blue pixel emitting blue light, and the drive device makes each of the red pixel, the green pixel, and the blue pixel emit light with identical light-emission timing, and not emit light with identical non-light-emission timing.

15. The electro-optical device according to claim 2, wherein the drive device adjusts the light-emission period of the plurality of pixels in a way that luminance of the plurality of pixels is nonlinear with respect to the luminance ratio of the image to be displayed.

16. A method for driving an electro-optical device, comprising:
driving a plurality of write scan lines non-sequentially; and
adjusting a light-emission period of the plurality of pixels according to a luminance ratio of an image, wherein the electro-optical device includes a plurality of pixels and the plurality of write scan lines including a predetermined number of the plurality of pixels as a unit.

17. A method for driving an electro-optical device, comprising adjusting a light-emission period of a plurality of pixels included in the electro-optical device in accordance with a luminance ratio of an image.

18. The method for driving an electro-optical device according to claim 17, wherein the light-emission period of the plurality of pixels is adjusted by adjusting non-light emission timing of the plurality of pixels.

19. The method for driving an electro-optical device according to claim 16, wherein the electro-optical device includes a plurality of erase scan lines corresponding to the plurality of write scan lines, and the plurality of erase scan lines are non-sequentially driven in response to a driving of the plurality of write scan lines.

20. The method for driving an electro-optical device according to claim 19, wherein the plurality of write scan lines are divided into zones every predetermined number as a unit in a sequential order and individually driven with respect to each zone so as to be driven non-sequentially.

21. The method for driving an electro-optical device according to claim 20, wherein the plurality of erase scan lines divided into zones corresponding to the zones of the plurality of write scan lines are driven individually with respect to each zone so as to be driven non-sequentially.

22. An electronic apparatus, comprising the electro-optical device according to claim 2.
